(19) United States
(12) Patent Application Publication
(10) Pub. No.: US 2021/0044987 A1
(43) Pub. Date: Feb. 11, 2021

(54) Practical Design Techniques for Cellular and WiFi Co-Enabled Systems

(71) Applicants: Yiming Huo, Victoria (CA); Xiaodai Dong, Victoria (CA); Wei Xu, Nanjing (CN); Marvin Yuen, Los Angeles, CA (US)

(72) Inventors: Yiming Huo, Victoria (CA); Xiaodai Dong, Victoria (CA); Wei Xu, Nanjing (CN); Marvin Yuen, Los Angeles, CA (US)

(21) Appl. No.: 16/944,035

(22) Filed: Jul. 30, 2020

Related U.S. Application Data
(63) Continuation-in-part of application No. 15/883,725, filed on Jan. 30, 2018, now Pat. No. 10,771,123.

(51) Int. Cl. H04W 16/18; H04B 7/0413; H04W 24/08

(52) U.S. Cl. CPC H04W 16/18; H04W 24/08; H04B 7/0413

(57) ABSTRACT

Generally, this disclosure provides practical systems and methods for distributed phased array multiple input multiple output (DPA-MIMO) communications. A system may comprise
a baseband processing unit;
a plurality of beamforming (BF) modules each of which comprises at least a beamforming antenna and a transceiver circuit comprising at least a downconverter that downconverts a beamformed antenna radio frequency signal to an intermediate frequency signal, and an upconverter that upconverts an intermediate frequency signal to radio frequency and sends to said beam forming antenna for transmission;
a plurality of intermediate frequency (IF) radios, each of which comprises a receive chain circuit that includes at least a downconverter that downconverts an intermediate frequency signal sent from said BF module to a baseband signal conveyed to said baseband processing unit, and a transmit chain circuit that includes at least an upconverter that upconverts a baseband signal received from said baseband processing unit to an intermediate frequency signal which is conveyed to said beamforming module;
and
a plurality of cables or any type of physical signal transmission medium, each of which connects one of said beamforming modules with one of said intermediate frequency radios.
Such said system may be designed for
Virtual reality wearable devices;
Virtual reality base station devices;
Self-driving and non-self-driving automotive vehicles;
Rotary-wing unmanned aerial vehicles;
Fixed-wing unmanned aerial vehicles;
High-altitude communication systems;
Foldable hand-held communication systems.

### CROSS-REFERENCE TO RELATED APPLICATIONS

The present Utility patent application claims priority benefit of the U.S. continuation-in-part application for patent Ser. No. 15/883,725, titled “DISTRIBUTED PHASED ARRAYS BASED MIMO (DPA-MIMO) FOR NEXT GENERATION WIRELESS USER EQUIPMENT HARDWARE DESIGN AND METHOD”, tiled on Jan. 30, 2018, under 35 U.S.C. 120. The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Provisional application No. 62/453,120, filed on Feb. 1, 2017.

U.S. patent application Ser. No. 15/883,725, filed on Jan. 30, 2018.

### FIELD OF THE INVENTION

One or more embodiments of the invention generally relate to mobile wireless communications. More particularly, the invention relates to multiple-input-multiple-output wireless communications device and system designs.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Current mobile computing devices such as, but not limited to, smartphones typically contain more wireless technologies and standards as time progresses. Support for more wireless technologies and standards may be typically achieved by additional hardware systems. Considerations are typically given for power, cost, and/or physical space when designing mobile computing devices for users.

Typically, current wireless communication systems require higher data rates to enable increasingly complex applications. Wireless communication systems may involve communications at frequencies as high as 10 Terahertz (THz). Communications at high frequencies may allow for more available spectrums and bandwidths, but may lead to high propagation loss and penetration loss. Spectral efficiency may be improved by multiple-input-multiple-output (MIMO) techniques.

The fifth generation and beyond (5G and Beyond) wireless communication systems such as 5G typically are expected to have peak data throughputs of approximately 10 gigabits per second or even higher. Higher data throughputs typically may be achieved by using a broader frequency range, improving data encoding and/or error correction, and/or improving signal reception. Higher frequencies such as those above 37 GHz are typically known to have a higher degree of signal interference from physical objects such as, but not limited to, buildings and/or people, compared to typically more traditional cellular and WiFi frequencies. Improvements in data encoding and/or error correction typically require considerations for hardware costs and/or power usage. Signal reception may typically be improved with additional hardware components such as, but not limited to, antennas and/or amplifiers and typically require considerations such as, but not limited to, hardware cost, power usage, and/or physical dimensions.

The following is an example of a specific aspect in the prior art that, while expected to be helpful to further educate the reader as to additional aspects of the prior art, is not to be construed as limited the present invention, or any embodiments thereof, to anything stated or implied therein or inferred thereupon. By way of educational background, another aspect of the prior art generally useful to be aware of is that some companies may implement wireless communication designs that comprise of a plurality of antennas to improve signal reception of a predetermined frequency range.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a top level system diagram of a distributed phased arrays based multiple-input-multiple-output (DPA-MIMO) wireless communication architecture, in accordance with an embodiment of the present invention;

FIG. 2 illustrates a detailed perspective of an exemplary distributed phase arrays based multiple-input-multiple-output system, in accordance with an embodiment of the present invention;

FIG. 3 illustrates a top level system diagram of a multiplexed DPA-MIMO wireless communication architecture, in accordance with an embodiment of the present invention;

FIG. 4 illustrates a detailed perspective of a multiplexed DPA-MIMO wireless communication system, in accordance with an embodiment of the present invention;

FIG. 5 illustrates a detailed perspective of an exemplary DPA-MIMO system based wearable virtual reality device, in accordance with an embodiment of the present invention;

FIG. 6 illustrates another detailed perspective of an exemplary DPA-MIMO system based wearable virtual reality device with multiple radiation beams, in accordance with an embodiment of the present invention;

FIG. 7 illustrates a detailed perspective of an exemplary DPA-MIMO system based virtual reality base station device with multiple radiation beams, in accordance with an embodiment of the present invention;

FIG. 8 illustrates a detailed perspective of an exemplary of a virtual reality application scenario with DPA-MIMO systems, in accordance with an embodiment of the present invention;

FIG. 9 illustrates a detailed perspective of an exemplary DPA-MIMO system based automotive vehicle system with multiple radiation beams, in accordance with an embodiment of the present invention;

FIG. 10 illustrates a detailed perspective of an exemplary DPA-MIMO system based rotary wing unmanned aerial vehicle system with multiple radiation beams, in accordance with an embodiment of the present invention;

FIG. 11 illustrates a detailed perspective of an exemplary DPA-MIMO system based fixed wing unmanned aerial vehicle system with multiple radiation beams, in accordance with an embodiment of the present invention;

FIG. 12 illustrates a detailed perspective of an exemplary DPA-MIMO system based high altitude platform communication box, in accordance with an embodiment of the present invention;

FIG. 13 illustrates a detailed perspective of an exemplary DPA-MIMO system based high altitude platform communication system with multiple radiation beams, in accordance with an embodiment of the present invention;

FIG. 14 illustrates a detailed perspective of an exemplary DPA-MIMO system based foldable handheld device, in accordance with an embodiment of the present invention;

FIG. 15 illustrates a flow chart illustrating an exemplary process for DPA-MIMO architecture based wireless communication systems, in accordance with an embodiment of the present invention.

FIG. 16 illustrates a flow chart illustrating an exemplary process for cellular and WiFi co-enabled DPA-MIMO system based wireless communication, in accordance with an embodiment of the present invention

### DETAILED DESCRIPTION OF SOME EMBODIMENTS

Some embodiments of the present invention and variations thereof, relate to wireless communications systems. Some of these embodiments may comprise computer software. In some of these embodiments, software may be integrated into hardware, including, without limitation, uniquely-designed hardware for running embodiment software.

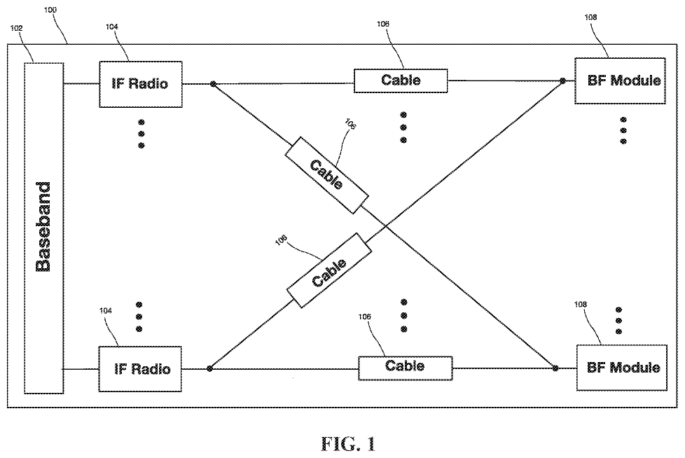

FIG. 1 illustrates a top level system diagram of a distributed phased array multiple-input-multiple-output (DPA-MIMO) wireless communication architecture, in accordance with an embodiment of the present invention. A DPA-MIMO wireless communication architecture 100 comprises of a baseband processing unit 102, one or more intermediate frequency (IF) radios 104, one or more cables 106, and one or more beamforming (BF) modules 108. Baseband processing unit 102 may handle all baseband signals for all IF radios 104. Electronic signals and/or power may travel from IF radios 104 through one or more cables 106 to one or more BF modules 108. BF module 106 may be configured to receive and/or transmit wireless data.

During a typical receive operation, henceforth also known as a downlink path, BF module 108 receives wireless signals and downconverts the wireless signals to an intermediate frequency (II) range. One or more RE modules 108 may form wireless receiving beams independently or jointly pointing to any directions with any beamwidths that are amenable to reception in a given propagation environment. The wireless signals in the IF range are sent through one or more cables 106 to one or more IF radios 104. At IF radio 104, IF range wireless signals are further downconverted in the frequency domain and sent to baseband processing unit 102 for processing.

During a typical transmit operation, henceforth also known as an uplink path, baseband processing unit 102 generates baseband data carrying information for communication and sends the baseband signals to one or more IF radios 104. IF radios 104 upconvert the baseband signals to one or more intermediate frequencies which are sent through one or more cables 106 to one or more BF modules 108. BF modules 108 upconvert any received IF signals to one or more predetermined transmission frequencies. One or more BF modules 108 further form a wireless transmission beams independently or jointly pointing to any directions with any beamwidths that are amenable to transmission in a given propagation environment and sends wireless signals at transmission frequencies.

One or more IF radios 104 may be connected to one BF module 108 through one or more cables 106. BF module 108 may exchange IF signals with a plurality of IF radios 104, which may be performed during instances when, but not limited to, some of the BF modules are powered down or stand by.

It may be appreciated by a person with ordinary skill in the art that baseband processing unit 102 includes a processor that may perform any type of process and/or algorithm on electronic signals. Processes and/or algorithms include, but are not limited to, digital beamforming techniques that process one or more signals from the one or more BF modules 108 independently or jointly. Digital beamforming may implement functions such as, but not limited to, removing interferences and/or enhancing a signal-to-noise ratio of the one or more processed signals and/or signals between antenna elements within one BF module 108. Baseband processing unit 102 may also perform baseband processing for other wireless protocols and/or standards.

It may be appreciated by a person with ordinary skill in the art that one or more cables 106 may be any type of medium capable of sending signals and/or power. Cables 106 may be, but not limited to, fiber optic cables, coaxial cables, IPEX/IPX cables, and/or ethernet cables with the any necessary coupling apparent by a person with ordinary skill in the art. In one embodiment of the present invention, cables 106 may be fiber optic cables carrying signals and/or power at various optical wavelengths.

It may be appreciated by a person with ordinary skill in the art that one or more cables 106 may carry signals at one or more frequencies for each cable 106. In one embodiment of the present invention a single cable 106 may carry multiple signals at a plurality of frequencies.

It may be appreciated by a person with ordinary skill in the art that a BF module 108 may include any type of beamforming antenna in any orientation. BF module 108 antennas may include, but not limited to, phased array antennas, steerable antennas, and/or reconfigurable antennas. In one embodiment of the present invention, a plurality of phased array antennas are orientated in a circular formation. In another embodiment of the present invention, a plurality of phased array antennas are orientated in a stacked up three-dimensional formation.

It may be appreciated by a person with ordinary skill in the art that a BF module 108 may operate at any frequency range. Frequency ranges may be, but not limited to, from 6 GHz to 10 THz, to handle various wireless technologies and standards which may include, but not limited to, cellular communications, wireless local area network (WLAN) communications, global navigation satellite system (GNSS) communications, millimeter wave (mmWave) communications, terahertz (THz) communications, visible-light communications, near field communications (NFC) and/or other wireless communications. In one embodiment of the present invention, a plurality of BF modules 108 may cover a plurality of standard wireless communications frequencies such that a DPA-MIMO wireless communications architecture 100 may function at a plurality of wireless communication protocols.

It may be appreciated by a person with ordinary skill in the art that any signal and/or power may be sent between one or more elements of DPA-MIMO wireless communication architecture 100. Signals and/or power sent between one or more elements may include, but not limited to, direct current (DC) power, control signals, reference signals, and/or feedback signals. In one embodiment of the present invention, an IF radio 104 may provide DC power to one or more BF modules 108 through one or more cables 106. In another embodiment of the present invention, one or more IF radios 104 may send control and reference signals through one or more cables 106 to one or more BF modules 108. BF modules 108 may send feedback signals back to IF radios 104 through cables 106.

It may be appreciated by a person with ordinary skill in the art that one or more elements of DPA-MIMO wireless communication architecture 100 may be combined into a single functional group or separated into a plurality of functional groups. In one embodiment of the present invention, a plurality of sets each comprising of an IF radio 104, a cable 106, and a BF module 108 may work individual functions such as, but not limited to, communications at a specific frequency, communications in a specific data stream, transmitting signals, and/or receiving signals. In another embodiment of the present invention, a plurality of sets comprising of one or more IF radios 104, cables 106, and BF modules 108 may work a single function such as, but not limited to, communications at a specific frequency, communications in a specific data stream, transmitting signals, and/or receiving signals.

It may be appreciated by a person with ordinary skill in the art that one or more BF modules 108 may cover a wide frequency range. A frequency ranged covered by one or more BF modules 108 may include, but not limited to, WiFi bands beyond 6 GHz, wireless gigabit (WiGig) bands from 57-71 GHz, and/or frequencies used by other wireless standards, licensed and unlicensed spectrum frequencies.

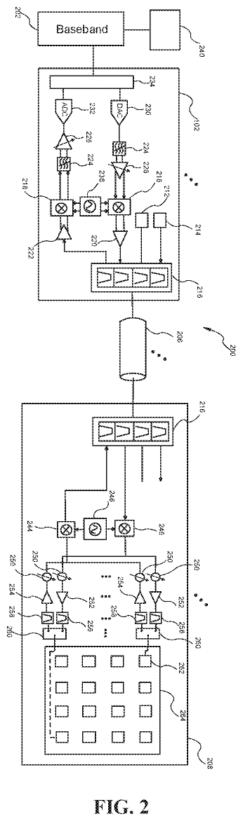

FIG. 2 illustrates a detailed perspective of an exemplary DPA-MIMO system 200, in accordance with an embodiment of the present invention. A DPA-MIMO wireless communication system 200 comprises of a baseband processing unit 202, one or more intermediate frequency (IF) radios 204, one or more cables 206, and one or more BF modules 208. Baseband processing unit 202 may be further connected to one or more radio frequency (RF) systems 240 which may include any RF front ends and/or antenna. apparent by a person with ordinary skill in the art.

BF module 208 comprises of an antenna array 264, one or more quadplexers 216, one or more local oscillators 248, one or more transmission signal mixers 246, one or more receive signal mixers 244, two or more phase shifters 250, one or more power amplifiers 252, one or more low-noise amplifiers 254, one or more transmission band filters 256, one or more tunable receive band filters 258, and one or more time controlled switches 260. Antenna array 264 may further comprise of one or more antenna elements 262.

Antenna array 264 may comprise of one or more antenna elements 262 which may be of heterogeneous or homogeneous type, shape, polarization, orientation and design. It may be appreciated by a person with ordinary skill in the art that antenna elements 262 may be selected and/or orientated based on specific DPA-MIMO wireless communication system 200 design and/or an application requirement.

IF radio module 204 comprises of one or more quadplexers 216, a control-reference generator 212, a power supply generator 214, one or more local oscillators 236, one or more low-pass filters 224, one or more automatic gain control units 226 and 228, one or more analog-to-digital converters (ADC) 232, a digital interface 234, one or more digital-to-analog converters (DAC) 230, a plurality of signal mixers 218, one or more transmission filters 224, and two or more signal amplifiers 220 and 222.

During typical operation within a BF module 208, one or more antenna elements 262 may be directly connected to a time controlled switch 260 that may route the signal for an uplink or a downlink path. A downlink path may have a tunable receive band filter 258 placed between a time controlled switch 260 and one or more low noise amplifiers 254. Each low-noise amplifiers 254 are followed by one or more phase shifters 250. Output signals from one or more phase shifters 250 of multiple paths may be combined to be downconverted to IF signals by a local oscillator 248 and a receive signal mixer 244. A generated IF signal may be then delivered to one or more quadplexers 216 in one or more IF radios 204 via one or more cables 206. A BF module 208 may comprise of transceiver circuits including multiple uplink and downlink paths connected to one or more antenna arrays 264.

A transmission path within BF module 208 may begin by receiving signals from quadplexer 216 via one or more cables 206. Signals received from quadplexer 216 may be upconverted by a local oscillator 248 and a transmission signal mixer 246. An output signal from transmission signal mixer 246 is sent to multiple phase shifters 250, one or more phase shifters 250 at a path where one or more power amplifiers 252 may direct an amplified output signal to one or more transmission band filters 256. A filtered output signal from the one or more transmission band filters 256 may be sent to a time controlled switch 260 and routed to a corresponding antenna element 262 for transmission.

During typical operation within a IF radio 204, one or more quadplexers 216 may deliver power from a power supply generator 214 to one or more BF modules 208 via one or more cables 206. A control-reference generator 212 generates control and/or reference signals. The control-reference generator 212 may also receive feedback signals that may include, but not limited to, an indication of communication quality and temperature of BF modules 208.

A downlink path within IF radio 204 begins with output signals received at one or more quadplexers 216. One or more signal amplifiers 222 may perform functions such as, but not limited to, amplification and transforming single-ended signals to differential signals. Signals from signal amplifiers 222 may be downconverted into one or more baseband analog signals by a local oscillator 236 and a signal mixer 218. The baseband analog signals may be filtered by one or more low-pass filters 224. An amplitude of a filtered baseband signal may be adjusted by one or more automatic gain control units 228. A filtered and/or amplified baseband signal may be digitized by an ADC 232. A digital interface 234 bridges the digitized baseband signal from ADC 232 to baseband processing unit 202.

An uplink path within IF radio 204 begins with digital baseband signals being transformed to analog baseband signals through one or more DAC 230. The analog baseband signals may be filtered through one or more low-pass filters 224. One or more automatic gain control units 226 may adjust the amplitude of a filtered analog baseband signal from the low-pass filters 224. Filtered and/or amplitude adjusted signals may be frequency upconverted by a local oscillator 236 and a signal mixer 218. One or more signal amplifiers 220 may further amplify an upconverted signal from signal mixer 218 before sending the upconverted signal to one or more quadplexers 216. Signals may be sent from quadplexers 216 to one or more BF modules 208 via one or more cables 206.

It may be appreciated by a person with ordinary skill in the art that baseband processing unit 202 includes a processor that may perform any type of process and/or algorithm on electronic signals. Processes and/or algorithms include, but are not limited to, digital beamforming techniques that process one or more signals from the one or more BF modules 208 independently or jointly. BF modules 208 may also perform functions such as, but not limited to, removing interferences and/or enhancing a single to noise ratio of the one or more processed signals and/or signals between antenna elements within one BF module 208. Baseband processing unit 202 may also perform baseband processing for other wireless protocols and/or standards.

It may be appreciated by a person with ordinary skill in the art that a BF module 208 may operate at any frequency range. Frequency ranges may be, but not limited to, from 6 to 60 GHz, to handle various wireless technologies and standards which may include, but not limited to, cellular communications, WLAN communications, GNSS communications, mmWave communications, THz communications, visible-light communications, NFC and/or other wireless communications. In one embodiment of the present invention, a plurality of BF modules 208 may cover a plurality of standard wireless communications frequencies such that a DPA-MIMO wireless communications system 200 may function at a plurality of wireless communication protocols.

It may be appreciated by a person with ordinary skill in the art that a plurality of IF radios 204 may operate at same or different frequency ranges, each of which operates at a frequency depending on the working frequency of its connected BF module 208. The operating frequencies of IF radio 204 and BF module 208 may be designed jointly.

It may be appreciated by a person with ordinary skill in the art that one or more quadplexers 216 may be multiplexers of any size and/or number. In one embodiment of the present invention, quadplexers 216 may be a hexplexer. In another embodiment of the present invention, quadplexers 216 may be a chain of smaller multiplexers.

It may be appreciated by a person with ordinary skill in the art that RF system 240 may be for any wireless communication standard. Wireless communication standards include, but not limited to, the 2^{nd} Generation cellular system (2G), the 3^{rd} Generation cellular system (3G), the 4^{th} Generation cellular system (4G), WLAN, Bluetooth, and/or other wireless standards. In one embodiment of the present invention, RF system 240 may function at Bluetooth, NFC, and 3G wireless standards.

It may be appreciated by a person with ordinary skill in the art that one or more time controlled switches 260 may be any type, combination, and/or number of time controlled switches. Time controlled switches 260 may be, but not limited to, N-pole N-throw switches. In one embodiment of the present invention, time controlled switches 260 may be a combination of single-pole double-throw switches and single-pole triple-throw switches.

It may be appreciated by a person with ordinary skill in the art that one or more time controlled switches 260 may be any switching and/or multiplexing device to achieve any duplexing scheme for one or more BF modules 208. BF modules 208 may perform duplexing such as, but not limited to, time-division duplexing and/or frequency-division duplexing. Duplexing schemes may be achieved with different types of switches and/or multiplexers as the one or more time controlled switches 260 in BF modules 208. Duplexing switches and/or multiplexers may include, but not limited to, diplexers and/or single-pole double-throw switches. In one embodiment of the present invention, one or more BF modules 208 may have time-division duplexing with one or more time controlled switches 260 as single-pole double-throw switches. In another embodiment of the present invention, one or more BF modules 208 may have frequency-division duplexing with one or more time controlled switches 260 replaced as diplexers.

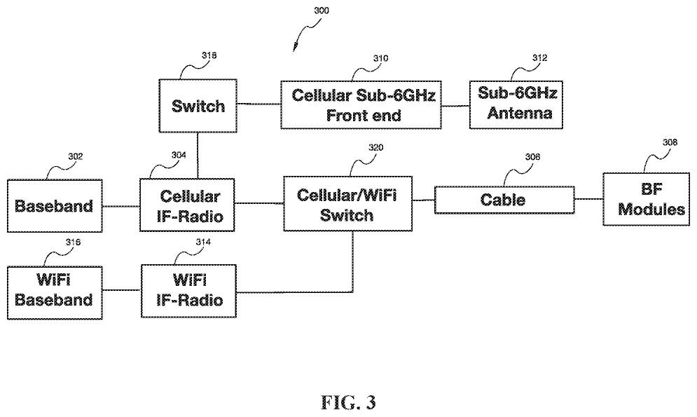

FIG. 3 illustrates a top level system diagram of a multiplexed distributed phased array multiple-input-multiple-output wireless communication architecture 300, in accordance with an embodiment of the present invention. A multiplex DPA-MIMO wireless communication architecture 300 comprises of a baseband processing unit 302, one or more cellular intermediate frequency (IF) radios 304, one or more cables 306, one or more beamforming 03.F) modules 308, one or more switches 318, a cellular sub-6 GHz front end 310, one or more cellular sub-6 GHz antennas 312, one or more cellular-WiFi switches 320, one or more WiFi IF radios 314, and a WiFi baseband processing unit 316. Baseband processing unit 302 may handle all baseband signals for all cellular IF radios 304. Electronic signals and/or power may travel from cellular IF radios 304 through one or more cables 306 to one or more BF modules 308. BF module 306 may be configured to receive and/or transmit wireless data. One or more cellular-WiFi switches 320 may be inserted between one or more cables 306 and one or more cellular IF radios 304. The cellular-WiFi switches 320 may enable a signal path between one or more cables 306 and one or more cellular IF radios 304 or one or more WiFi IF radios 314. One or more switches 318 may be inserted between one or more cellular IF radios 304 and a cellular sub-6 GHz front end 310. Cellular sub-6 GHz front end 310 may operate below 6 GHz and may include power amplifiers, low-noise amplifiers, antenna switching modules, and/or filters. One or more cellular sub-6 GHz antennas 312 may be connected to every cellular sub-6 GHz front end 310.

During a typical receive operation, henceforth also known as a downlink path, BF module 308 receives wireless signals and downconverts the wireless signals to an intermediate frequency (IF) range. BF modules 308 may form wireless transmission beams independently or jointly pointing to any directions with any beamwidths that are amenable to reception in a given propagation environment. The wireless signals in the cellular IF range are sent through one or more cables 306 to one or more cellular IF radios 304. At IF radio 304, IF range wireless signals are further downconverted in the frequency domain and sent to baseband processing unit 302 for processing.

During a typical transmit operation, henceforth also known as an uplink path, baseband processing unit 302 generates baseband data carrying information for communication and sends the baseband signals to one or more cellular IF radios 304. Cellular IF radios 304 upconverts the baseband signals to one or more intermediate frequencies which are sent through one or more cables 306 to one or more BF modules 308. BF modules 308 upconverts any received IF signals to one or more predetermined transmission frequencies. BF modules 308 further forms a wireless transmission beams independently or jointly pointing to any directions with any beamwidths that are amenable to transmission in a given propagation environment and sends wireless signals at transmission frequencies.

Circuit paths may be enabled or disabled based on control signals given to one or more switches 318 and one or more cellular-WiFi switches 320. When one or more switches 318 open a signal path between one or more cellular IF radios 304 and a cellular sub-6 GHz front end 310, the one or more cellular-WiFi switches 320 may disable the signal paths between the one or more cables 306 and the one or more WiFi IF radios 314. In a similar fashion, when one or more switches 318 close a signal path between one or more cellular IF radios 304 and a cellular sub-6 GHz front end 310, the one or more cellular-WiFi switches 320 may enable the signal paths between the one or more cables 306 and the one or more WiFi IF radios 314.

It may be appreciated by a person with ordinary skill in the art that enabling and/or disabling circuit paths with one or more switches 318 and/or cellular-WiFi switches 320 may be used to control the usage of one or more BF modules 308 and/or input/output signals to and from baseband processing unit 302. In one embodiment of the present invention, WiFi communications may be established by disabling all circuit paths to the cellular sub-6 GHz front end 310 and enabling one or more circuit paths to cellular cellular IF radios 304. In another embodiment of the present invention, time slicing usage time of BF modules 308 and/or baseband processing unit 302 may be achieved by modulating control of one or more switches 318 and/or one or more cellular-WiFi switches 320.

It may be appreciated by a person with ordinary skill in the art that baseband processing unit 302 includes a processor that may perform any type of process and/or algorithm on electronic signals. Processes and/or algorithms include, but are not limited to, digital beamforming techniques that process one or more signals from the one or more BF modules 308 independently or jointly. BF modules 308 may also perform functions such as, but not limited to, removing interferences and/or enhancing a single to noise ratio of the one or more processed signals and/or signals between antenna elements within one BF module 308. Baseband processing unit 302 may also perform baseband processing for other wireless protocols and/or standards.

It may be appreciated by a person with ordinary skill in the art that a BF module 308 may operate at any frequency range. Frequency ranges may be, but not limited to, from 6 to 600 GHz, to handle various wireless technologies and standards which may include, but not limited to, cellular communications, WLAN communications, GNSS communications, mmWave communications, THz communications, visible-light communications, NFC and/or other wireless communications. In one embodiment of the present invention, a plurality of BF modules 308 may cover a plurality of standard wireless communications frequencies such that a multiplexed DPA-MIMO wireless communications architecture 300 may function at a plurality of wireless communication protocols.

It may be appreciated by a person with ordinary skill in the art that one or more cables 306 may be any type of medium capable of sending signals and/or power. Cables 306 may be, but not limited to, fiber optic cables, coaxial cables, and/or ethernet cables with the any necessary coupling apparent by a person with ordinary skill in the art. In one embodiment of the present invention, cables 306 may be fiber optic cables carrying signals and/or power at various optical wavelengths.

It may be appreciated by a person with ordinary skill in the art that one or more cables 306 may carry signals at one or more frequencies for each cable 306. In one embodiment of the present invention a single cable 306 may carry multiple signals at a plurality of frequencies.

It may be appreciated by a person with ordinary skill in the art that a BF module 308 may include any type of antenna in any orientation. BF module 308 antennas may include, but not limited to, phased array antennas, steerable antennas, and/or reconfigurable antennas. In one embodiment of the present invention, a plurality of phased array antennas are orientated in a circular formation.

It may be appreciated by a person with ordinary skill in the art that any signal and/or power may be sent between one or more elements of DPA-MIMO wireless communication architecture 300. Signals and/or power sent between one or more elements may include, but not limited to, direct-current (DC) power, control signals, reference signals, and/or feedback signals. In one embodiment of the present invention, a cellular IF radio 304 may provide DC power to one or more 131 modules 308 through one or more cables 306. In another embodiment of the present invention, one or more cellular IF radios 304 may send control and reference signals through one or more cables 306 to one or more BF modules 308. BF modules 308 may send feedback signals back to cellular IF radios 304 through cables 306.

It may be appreciated by a person with ordinary skill in the art that one or more elements of DPA-MIMO wireless communication system 300 may be combined into a single functional group or separated into a plurality of functional groups. In one embodiment of the present invention, a plurality of sets each comprising of a cellular IF radio 304, a cable 306, and a BF module 308 may work individual functions such as, but not limited to, communications at a specific frequency, communications in a specific data stream, transmitting signals, and/or receiving signals. In another embodiment of the present invention, a plurality of sets comprising of one or more cellular IF radios 304, cables 306, and BF modules 308 may work a single function such as, but not limited to, communications at a specific frequency, communications in a specific data stream, transmitting signals, and/or receiving signals.

It may be appreciated by a person with ordinary skill in the art that one or more BF modules 308 may cover a wide frequency range. A frequency ranged covered by one or more BF modules 308 may include, but not limited to, WiFi bands beyond 6 GHz, wireless gigabit (WiGig) bands from 57-71 GHz, and/or frequencies used by other wireless standards, and/or licensed and unlicensed spectrum frequencies.

It may be appreciated by a person with ordinary skill in the art that one or more cellular-IF radios 304, one or more switches 318, a cellular sub-6 GHz front end 310, one or more cellular sub-6 GHz antennas 312, one or more cellular-WiFi switches 320, one or more WiFi IF radios 314, and a WiFi baseband processing unit 316 may be hardware designed for any wireless frequency and/or protocol. In one embodiment of the present invention, one or more switches 318, a cellular sub-6 GHz front end 310, and one or more cellular sub-6 GHz antennas 312 may be switches, front ends, and antennas designed for super-high frequency wireless communications.

It may be appreciated by a person with ordinary skill in the art that multiplexed DPA-MIMO wireless communication architecture 300 and any comprising elements may be configured for any wireless communication frequencies. Wireless communication frequencies may include, but not limited to, Bluetooth, NFC, cellular frequencies, and/or radio frequencies. In one embodiment of the present invention, one or more WiFi IF radios 314 and one or more WiFi baseband processing units 316 may be configured for Bluetooth frequencies while one or more cellular sub-6 GHz front ends 310 and one or more cellular sub-6 GHz antennas 312 may be configured for NFC frequencies.

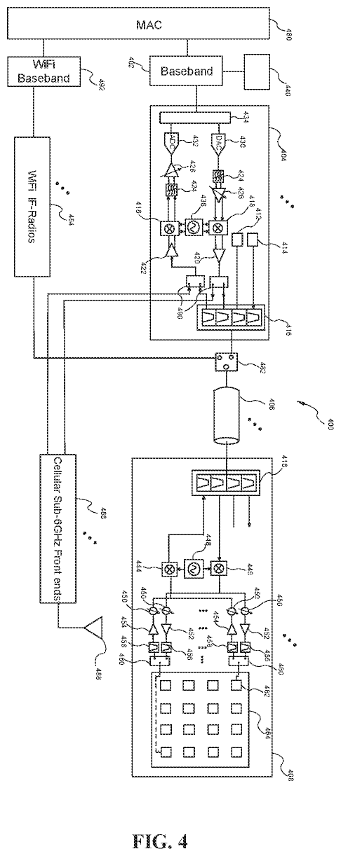

FIG. 4 illustrates a detailed perspective of a multiplexed DPA-MIMO wireless communication system 400, in accordance with an embodiment of the present invention. A multiplexed DPA-MIMO wireless communication system 400 comprises of a baseband processing unit 402, one or more IF radios 404, one or more cables 406, one or more BF modules 408, a medium access control (MAC) block 480, one or more cellular-WiFi switches 482, one or more WiFi IF radios 484, one or more WiFi baseband processing units 492, one or more cellular sub-6 GHz front ends 486, and one or more cellular sub-6 GHz antennas 488. Baseband processing unit 402 may be further connected to one or more radio frequency (RF) systems 440 which may include any RF front ends and/or antenna apparent by a person with ordinary skill in the art.

BF module 408 comprises of an antenna array 464, one or more quadplexers 416, one or more local oscillators 448, one or more transmission signal mixers 446, one or more receive signal mixers 444, one or more phase shifters 450, one or more power amplifiers 452, one or more low noise amplifiers 454, one or more transmission band filters 456, one or more tunable receive band filters 458, and one or more time controlled switches 460. Antenna array 464 may further comprise of one or more antenna elements 462.

Antenna array 464 may comprise of one or more antenna elements 462 which may be of heterogeneous type, shape, and design. It may be appreciated by a person with ordinary skill in the art that antenna elements 462 may be selected and/or orientated based on specific multiplexed DPA-MIMO wireless communication system 400 design and/or an application requirement.

IF radio module 404 comprises of one or more quadplexers 416, a control-reference generator 412, a power supply generator 414, a local oscillator 436, one or more low-pass filters 424, one or more automatic gain control units 426 and 428, one or more ADC 432, a digital interface 434, one or more DAC 430, a plurality of signal mixers 418, one or more transmission filters 424, two or more signal amplifiers 420 and 422, and one or more switches 490.

MAC block 480 may be designed to work with signals from baseband processing unit 402 and WiFi baseband processing unit 492. MAC block 480 may contain algorithms and/or protocols which may enable communication between baseband processing unit 402 and WiFi baseband processing unit 492. Communication between baseband processing unit 402 and WiFi baseband processing unit 492 may include, but not limited to, cooperation between cellular and WiFi functions based on usage and/or application scenarios, supporting co-enabling cellular and WiFi functions in baseband processing unit 402 and/or WiFi baseband processing unit 492, and/or carrier frequency aggregation of license and unlicensed frequency bands.

During typical operation within a BF module 408, one or more antenna elements 462 may be directly connected to a time controlled switch 460 that may route the signal for an uplink or a downlink path. A downlink path may have a tunable receive band filter 458 placed between a time controlled switch 460 and one or more low noise amplifiers 454. Each low-noise amplifiers 454 are followed by a phase shifter 450, Output signals from one or more phase shifters 450 may be combined to be downconverted to IF signals by a local oscillator 448 and a receive signal mixer 444. A generated IF signal may be then delivered to one or more quadplexers 416 in one or more IF radios 404 via one or more cables 406.

A transmission path within BF module 408 may begin by receiving signals from quadplexer 416 via one or more cables 406. Signals received from quadplexer 416 may be upconverted by a local oscillator 448 and a transmission signal mixer 446. An output signal from transmission signal mixer 446 is sent to multiple phase shifters 450, one phase shifter 450 at a path where one or more power amplifiers 452 may direct an amplified output signal to one or more transmission band filters 456. A filtered output signal from the one or more transmission band filters 456 may be sent to a time controlled switch 460 and routed to a corresponding antenna element 462 for transmission.

During typical operation within an IF radio 404, one or more quadplexers 416 may deliver power from a power supply generator 414 to one or more BF modules 408 via one or more cables 406. A control-reference generator 412 generates control and/or reference signals and may also receive feedback signals.

A downlink path within IF radio 404 begins with output signals received at one or more quadplexers 416. One or more signal amplifiers 422 may perform functions such as, but not limited to, amplification and transforming single-ended signals to differential signals. Signals from signal amplifiers 422 may be downconverted into one or more baseband analog signals by a local oscillator 436 and a signal mixer 418. The baseband analog signals may be filtered by one or more low-pass filters 424. An amplitude of a filtered baseband signal may be adjusted by one or more automatic gain control units 428. A filtered and/or amplified baseband signal may be digitized by an ADC 432. A digital interface 434 bridges the digitized baseband signal from ADC 432 to baseband processing unit 402.

An uplink path within IF radio 404 begins with digital baseband signals being transformed to analog baseband signals through one or more DAC 430. The analog baseband signals may be filtered through one or more low pass filters 424. One or more automatic gain control units 426 may adjust the amplitude of a filtered analog baseband signal from the low-pass filters 424. Filtered and/or amplitude adjusted signals may be frequency upconverted by a local oscillator 436 and a signal mixer 418. One or more signal amplifiers 420 may further amplify an upconverted signal from signal mixer 418 before sending the upconverted signal to one or more quadplexers 416. Signals may be sent from quadplexers 416 to one or more BF modules 408 via one or more cables 406.

Circuit paths may be enabled or disabled based on control signals given to one or more switches 490 and one or more cellular-WiFi switches 482. When one or more switches 490 open a signal path between the two or more signal amplifiers 420 and 422 and the one or more cellular sub-6 GHz front ends 486, the one or more cellular-WiFi switches 482 may disable the signal paths between the one or more cables 406 and the one or more WiFi IF radios 484. In a similar fashion, when one or more switches 490 close a signal path between between the two or more signal amplifiers 420 and 422 and the one or more cellular sub-6 GHz front ends 486, the one or more cellular-WiFi switches 482 may enable the signal paths between the one or more cables 406 and the one or more WiFi IF radios 484.

It may he appreciated by a person with ordinary skill in the art that enabling and/or disabling circuit paths with one or more switches 490 and/or cellular-WiFi switches 482 may be used to control the usage of one or more BF modules 408 and/or input/output signals to and from baseband processing unit 402. In one embodiment of the present invention, WiFi communications may be established by disabling all circuit paths to the one or more cellular sub-6 GHz front ends 486 and enabling one or more circuit paths to WiFi IF radios 484. In another embodiment of the present invention, time slicing usage time of BF modules 408 and/or baseband processing unit 402 may be achieved by modulating control of one or more switches 490 and/or one or more cellular-WiFi switches 482.

It may be appreciated by a person with ordinary skill in the art that a BF module 408 may operate at any frequency range. Frequency ranges may be, but not limited to, from 6 to 600 GHz, to handle various wireless technologies and standards which may include, but not limited to, cellular communications, WLAN communications, GNSS communications, mmWave communications, THz communications, visible-light communications, NEC and/or other wireless communications. In one embodiment of the present invention, a plurality of BF modules 408 may cover a plurality of standard wireless communications frequencies such that a multiplexed DPA-MIMO wireless communications system 400 may function at a plurality of wireless communication protocols.

It may be appreciated by a person with ordinary skill in the art that one or more quadplexers 416 may be multiplexers of any size and/or number. In one embodiment of the present invention, quadplexers 416 may be a hexplexer. In another embodiment of the present invention, quadplexers 416 may be a chain of smaller multiplexers.

It may be appreciated by a person with ordinary skill in the art that one or more IF radios 404, one or more switches 490, one or more cellular sub-6 GHz front end 486, one or more cellular sub-6 GHz antennas 488, one or more cellular-WiFi switches 482, one or more WiFi IF radios 484, and a WiFi baseband processing unit 492 may be hardware designed for any wireless frequency and/or protocol. In one embodiment of the present invention, one or more switches 490, one or more cellular sub-6 GHz front ends 486, and one or more cellular sub-6 GHz antennas 488 may be switches, front ends, and antennas designed for super-high frequency wireless communications.

It may be appreciated by a person with ordinary skill in the art that one or more time controlled switches 460 may be any type, combination, and/or number of time controlled switches. Time controlled switches 460 may be, but not limited to, N-pole N-throw switches. In one embodiment of the present invention, time controlled switches 460 may be a combination of single-pole double-throw switches and single-pole triple-throw switches.

It may be appreciated by a person with ordinary skill in the art that one or more time controlled switches 460 may be any switching and/or multiplexing device to achieve any duplexing scheme for one or more BF modules 408. BF modules 408 may perform duplexing such as, but not limited to, time-division duplexing and/or frequency-division duplexing. Duplexing schemes may be achieved with different types of switches and/or multiplexers as the one or more time controlled switches 460 in BF modules 408. Duplexing switches and/or multiplexers may include, but not limited to, diplexers and/or single pole double throw switches. In one embodiment of the present invention, one or more BF modules 408 may have time division duplexing with one or more time controlled switches 460 as single-pole double-throw switches. In another embodiment of the present invention, one or more BF modules 408 may have frequency-division duplexing with one or more time controlled switches 460 as diplexers.

It may be appreciated by a person with ordinary skill in the art that RF system 440 may be for any wireless communication standard. Wireless communication standards include, but not limited to, 2G, 3G, 4G, WLAN, Bluetooth, and/or other wireless standards. In one embodiment of the present invention, RF system 440 may function at Bluetooth, NFC, and 3G wireless standards.

It may be appreciated by a person with ordinary skill in the art that multiplexed DPA-MIMO wireless communication system 400 and any comprising elements may be configured for any wireless communication frequencies. Wireless communication frequencies may include, but not limited to, Bluetooth, NFC, cellular frequencies, and/or radio frequencies. In one embodiment of the present invention, one or more WiFi IF radios 484 and one or more WiFi baseband processing units 492 may be configured for Bluetooth frequencies while one or more cellular sub-6 GHz front ends 486 and one or more cellular sub-6 GHz antennas 488 may be configured for NFC frequencies.

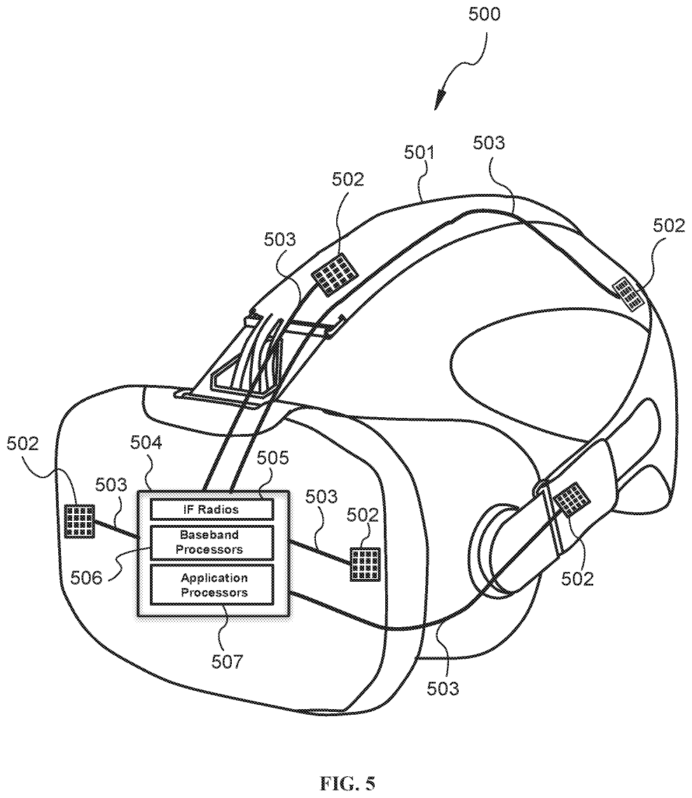

FIG. 5 illustrates a top level system diagram of a distributed phased arrays multiple-input-multiple-output (DPA-MIMO) wireless communication system based wearable virtual reality device, in accordance with an embodiment of the present invention. A DPA-MIMO system based wearable virtual reality device 500 comprises of a virtual reality device headset 501, one or more beamforming (BF) modules 502, one or more cables 503, one or more main logic boards 504, one or more intermediate frequency (IF) radios 505, one or more baseband processors 506, one or more application processors 507. Application processors 507 may handle all baseband signals from baseband processors 506. Baseband processors 506 may handle all IF signals for all IF radios 505. Electronic signals and/or power may travel from one or more main logic boards 504 through one or more cables 503 to one or more BF modules 502. BF module 502 may be configured to receive and/or transmit wireless data. One or more BF modules 502 may be placed on/in the device in a distributed way.

During a typical receive operation, henceforth also known as a downlink path, BF module 502 receives wireless signals and downconverts the wireless signals to an intermediate frequency (IF) range. One or more BF modules 502 may form wireless receiving beams independently or jointly pointing to any directions with any beamwidths that are amenable to reception in a given propagation environment. The wireless signals in the IF range are sent through one or more cables 503 to one or more main logic boards 504. At IF radios 505, IF range wireless signals are further downconverted in the frequency domain and sent to baseband processors 506 for processing. At application processors 507, baseband signals are further processed for application purposes.

During a typical transmit operation, henceforth also known as an uplink path, baseband processors 506 process application-layer signals from application processors 507 and generate baseband data carrying information for communication and send the baseband signals to one or more IF radios 505. IF radios 505 upconvert the baseband signals to one or more intermediate frequencies which are sent through one or more cables 503 to one or more BF modules 502. BF modules 502 upconvert any received IF signals to one or more predetermined transmission frequencies. One or more BF modules 502 further form one or more wireless transmission beams independently or jointly pointing to any directions with any beamwidths that are amenable to transmission in a given propagation environment and sends wireless signals at transmission frequencies.

One or more IF radios 505 may be connected to one or more BF modules 502 through one or more cables 503. BF modules 502 may exchange IF signals with a plurality of IF radios 505, which may be performed during instances when, but not limited to, some of the BF modules are powered down or stand by.

It may be appreciated by a person with ordinary skill in the art that baseband processors 506 include a processor that may perform any type of process and/or algorithm on electronic signals. Processes and/or algorithms include, but are not limited to, digital beamforming techniques that process one or more signals from the one or more BF modules 502 independently or jointly. Digital beamforming may implement functions such as, but not limited to, removing interferences and/or enhancing a signal-to-noise ratio of the one or more processed signals and/or signals between antenna elements within one BF module 502. Baseband processors 506 may also perform baseband processing for other wireless protocols and/or standards.

It may be appreciated by a person with ordinary skill in the art that one or more cables 503 may be any type of medium capable of sending signals and/or power. Cables 503 may be, but not limited to, fiber optic cables, coaxial cables, IPEX/IPX cables, and/or ethernet cables with the any necessary coupling apparent by a person with ordinary skill in the art, in one embodiment of the present invention, cables 503 may be fiber optic cables carrying signals and/or power at various optical wavelengths.

It may be appreciated by a person with ordinary skill in the art that one or more cables 503 may carry signals at one or more frequencies for each cable 503. In one embodiment of the present invention a single cable 503 may carry multiple signals at a plurality of frequencies.

It may be appreciated by a person with ordinary skill in the art that a BF module 502 may include any type of beamforming antenna in any orientation. BF module 502 antennas may include, but not limited to, phased array antennas, steerable antennas, and/or reconfigurable antennas. In one embodiment of the present invention, a plurality of phased array antennas are orientated in a circular formation. In another embodiment of the present invention, a plurality of phased array antennas are orientated in a stacked up three-dimensional formation.

It may be appreciated by a person with ordinary skill in the art that a BF module 502 may operate at any frequency range. Frequency ranges may be, but not limited to, from 1 GHz to 10 THz, to handle various wireless technologies and standards which may include, but not limited to, cellular communications, wireless local area network (WLAN) communications, global navigation satellite system (GNSS) communications, millimeter wave (mmWave) communications, satellite communications, terahertz (THz) communications, visible-light communications, near field communications (NFC) and/or other wireless communications. In one embodiment of the present invention, a plurality of BF modules 502 may cover a plurality of standard wireless communications frequencies such that a DPA-MIMO system based virtual reality device 500 may function at a plurality of wireless communication protocols.

It may be appreciated by a person with ordinary skill in the art that any signal and/or power may be sent between one or more elements of DPA-MIMO system based virtual reality wearable device 500. Signals and/or power sent between one or more elements may include, but not limited to, direct current (DC) power, control signals, reference signals, and/or feedback signals. In one embodiment of the present invention, an IF radio 505 may provide DC power to one or more BF modules 502 through one or more cables 503. In another embodiment of the present invention, one or more IF radios 505 may send control and reference signals through one or more cables 503 to one or more BF modules 502. BF modules 502 may send feedback signals back to IF radios 505 through cables 503.

It may be appreciated by a person with ordinary skill in the art that one or more elements of the DPA-MIMO system based virtual reality wearable device 500 may be combined into a single functional group or separated into a plurality of functional groups. In one embodiment of the present invention, a plurality of sets each comprising of an IF radio 505, a cable 503, and a BF module 502 may work individual functions such as, but not limited to, communications at a specific frequency, communications in a specific data stream, transmitting signals, and/or receiving signals. In another embodiment of the present invention, a plurality of sets comprising of one or more IF radios 505, cables 503, and BF modules 502 may work a single function such as, but not limited to, communications at a specific frequency, communications in a specific data stream, transmitting signals, and/or receiving signals.

It may be appreciated by a person with ordinary skill in the art that one or more BF modules 502 may cover a wide frequency range. A frequency range covered by one or more BF modules 502 may include, but not limited to, WiFi bands above 6 GHz, wireless gigabit (WiGig) bands from 57-71 GHz, and/or frequencies used by other wireless standards, licensed and unlicensed spectrum frequencies.

It may be appreciated by a person with ordinary skill in the art that virtual reality wearable device headset 501 includes one or more processors that may perform any type of process and/or algorithm on electronic signals. Processes and/or algorithms include, but are not limited to, digital beamforming techniques that process one or more signals from the one or more BF modules 502 independently or jointly. BF modules 502 may also perform functions such as, but not limited to, removing interferences and/or enhancing a single to noise ratio of the one or more processed signals and/or signals between antenna elements within one BF module 502.

It may be appreciated by a person with ordinary skill in the art that a DPA-MIMO system based virtual reality wearable device 500 may be for any wireless communication standard. Wireless communication standards include, but not limited to, the 2^{nd} Generation cellular system (2G), the 3^{rd} Generation cellular system (3G), the 4^{th} Generation cellular system (4G), the 5^{th} Generation cellular system (5G), WLAN, Bluetooth, and/or other wireless standards. In one embodiment of the present invention, a DPA-MIMO system based wearable virtual reality device 500 may function at Bluetooth, NFC, and 3G/4E1/5G wireless standards.

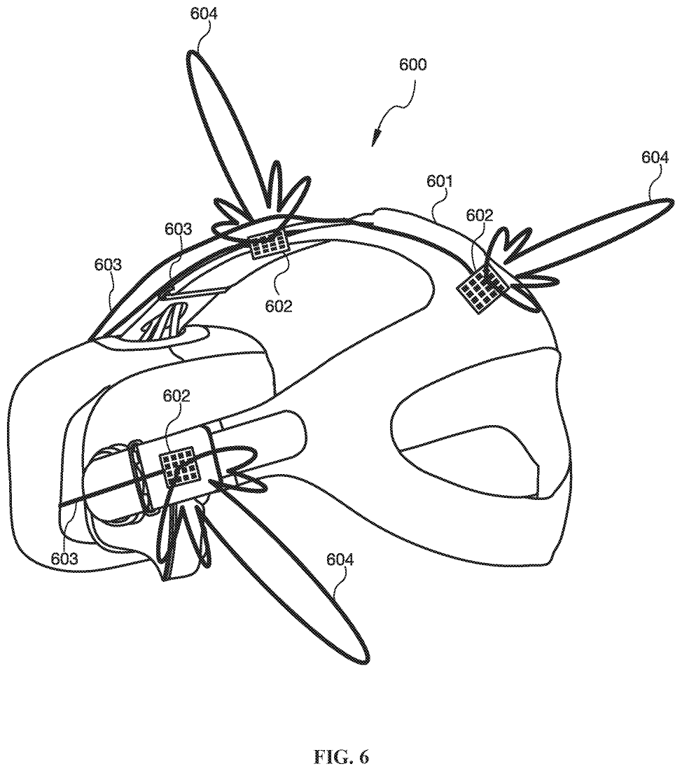

FIG. 6 illustrates another detailed perspective of an exemplary DPA-MIMO system based virtual reality device 600, in accordance with an embodiment of the present invention. A DPA-MIMO system based virtual reality device 600 comprises of a virtual reality device headset 601, one or more BF modules 602, one or more cables 603, and one or more radiation beams 604.

It may be appreciated by a person with ordinary skill in the art that virtual reality device headset 601 includes one or more processors that may perform any type of process and/or algorithm on electronic signals. Processes and/or algorithms include, but are not limited to, digital beamforming techniques that process one or more signals from the one or more BF modules 602 independently or jointly. BF modules 602 may also perform functions such as, but not limited to, removing interferences and/or enhancing a signal to noise ratio of the one or more processed signals and/or signals between antenna. elements within one BF module 602.

It may be appreciated by a person with ordinary skill in the art that a BF module 602 may operate at any frequency range. Frequency ranges may be, but not limited to, from 1 GHz to 10 THz, to handle various wireless technologies and standards which may include, but not limited to, cellular communications, WLAN communications, GNSS communications, mmWave communications, satellite communications, THz communications, visible-light communications, NFC and/or other wireless communications. In one embodiment of the present invention, a plurality of BF modules 602 may cover a plurality of standard wireless communications frequencies such that a DPA-MIMO wireless communications system based virtual reality device 600 may function at a plurality of wireless communication protocols.

It may be appreciated by a person with ordinary skill in the art that a DPA-MIMO system based virtual reality device 600 may be for any wireless communication standard. Wireless communication standards include, but not limited to, the 2^{nd} Generation cellular system (2G), the 3^{rd} Generation cellular system (3G), the 4^{th} Generation cellular system (4G), the 5^{th} Generation cellular system (5G), WLAN, Bluetooth, and/or other wireless standards, in one embodiment of the present invention, 600 may function at Bluetooth, NFC, and 3G/4G/5G wireless standards.

It may be appreciated by a person with ordinary skill in the art that a virtual reality device headset 601 may be any device capable of interfacing with a user. Virtual reality device headset 601 may include, but not limited to, wearable smart glasses, brain-machine interface devices, implantable devices, and/or personal computing devices. In one embodiment of the present invention, virtual reality device headset 601 may be a wearable display with an implanted control device.

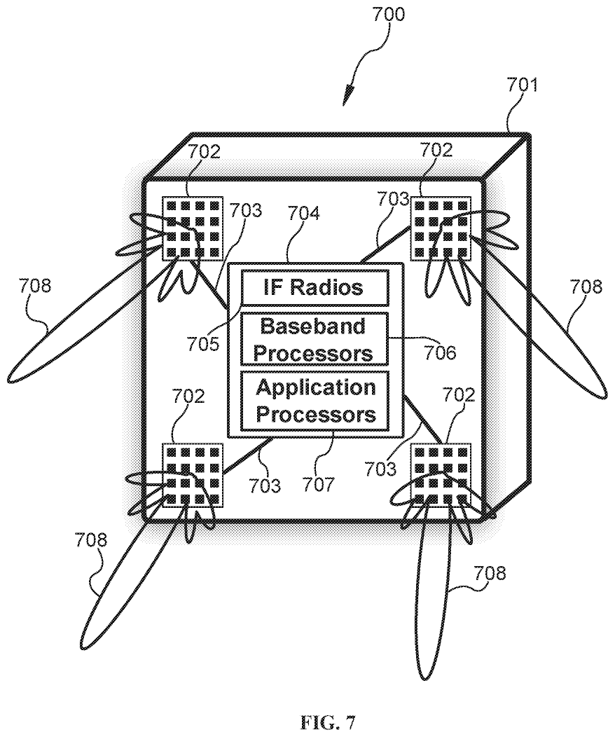

FIG. 7 illustrates a detailed perspective of an exemplary DPA-MIMO system based virtual reality base station device with multiple radiation beams in accordance with an embodiment of the present invention. A DPA-MIMO wireless communication system based virtual reality base station device 700 comprises of a virtual reality base station device housing 701, one or more BF modules 702, one or more cables 703, one or more main logic boards 704, one or more intermediate frequency (IF) radios 705, one or more baseband processors 706, one or more application processors 707, and one or more radiation beams 708. Application processors 707 may handle all baseband signals from baseband processors 706. Baseband processors 706 may handle all baseband signals for all IF radios 705. Electronic signals and/or power may travel from one or more main logic boards 704 through one or more cables 703 to one or more BF modules 702. BF module 702 may be configured to receive and/or transmit wireless data. One or more BF modules 702 may be placed on/in the device in a distributed way.

During a typical receive operation, henceforth also known as a downlink path, BF module 702 receives wireless signals and downconverts the wireless signals to an intermediate frequency (IF) range. One or more BF modules 702 may form wireless receiving beams independently or jointly pointing to any directions with any beamwidths that are amenable to reception in a given propagation environment. The wireless signals in the IF range are sent through one or more cables 703 to one or more main logic boards 704. At IF radios 705, IF range wireless signals are further downconverted in the frequency domain and sent to baseband processors 706 for processing. At application processors 707, baseband signals are further processed for application purposes.

During a typical transmit operation, henceforth also known as an uplink path, baseband processors 706 process application-layer signals from application processors 707 and generate baseband data carrying information for communication and send the baseband signals to one or more IF radios 705. IF radios 705 upconvert the baseband signals to one or more intermediate frequencies which are sent through one or more cables 703 to one or more BF modules 702. BF modules 702 upconvert any received IF signals to one or more predetermined transmission frequencies. One or more BF modules 702 further form one or more wireless transmission beams independently or jointly pointing to any directions with any beamwidths that are amenable to transmission in a given propagation environment and sends wireless signals at transmission frequencies.

One or more IF radios 705 may be connected to one or more BF modules 702 through one or more cables 703. BF modules 702 may exchange IF signals with a plurality of IF radios 705, which may be performed during instances when, but not limited to, some of the BF modules are powered down or stand by.

It may be appreciated by a person with ordinary skill in the art that baseband processors 706 include a processor that may perform any type of process and/or algorithm on electronic signals. Processes and/or algorithms include, but are not limited to, digital beamforming techniques that process one or more signals from the one or more BF modules 702 independently or jointly. Digital beamforming may implement functions such as, but not limited to, removing interferences and/or enhancing a signal-to-noise ratio of the one or more processed signals and/or signals between antenna elements within one BF module 702. Baseband processors 702 may also perform baseband processing for other wireless protocols and/or standards.

It may be appreciated by a person with ordinary skill in the art that one or more cables 703 may be any type of medium capable of sending signals and/or power. Cables 703 may be, but not limited to, fiber optic cables, coaxial cables, IPEX/IPX cables, and/or ethernet cables with the any necessary coupling apparent by a person with ordinary skill in the art. In one embodiment of the present invention, cables 703 may be fiber optic cables carrying signals and/or power at various optical wavelengths.

It may be appreciated by a person with ordinary skill in the art that one or more cables 703 may carry signals at one or more frequencies for each cable 703. In one embodiment of the present invention a single cable 703 may carry multiple signals at a plurality of frequencies.

It may be appreciated by a person with ordinary skill in the art that a BF module 702 may include any type of beamforming antenna in any orientation. BF module 702 antennas may include, but not limited to, phased array antennas, steerable antennas, and/or reconfigurable antennas. In one embodiment of the present invention, a plurality of phased array antennas are orientated in a circular formation. In another embodiment of the present invention, a plurality of phased array antennas are orientated in a stacked up three-dimensional formation.

It may be appreciated by a person with ordinary skill in the art that a BF module 702 may operate at any frequency range. Frequency ranges may be, but not limited to, from 1 GHz to 10 THz, to handle various wireless technologies and standards which may include, but not limited to, cellular communications, wireless local area network (WLAN) communications, global navigation satellite system (GNSS) communications, millimeter wave (mmWave) communications, satellite communications, terahertz (THz) communications, visible-light communications, near field communications (NFC) and/or other wireless communications. In one embodiment of the present invention, a plurality of BF modules 702 may cover a plurality of standard wireless communications frequencies such that a DPA-MIMO wireless communications system based virtual reality base station device 700 may function at a plurality of wireless communication protocols.

It may be appreciated by a person with ordinary skill in the art that any signal and/or power may be sent between one or more elements of DPA-MIMO system based virtual reality base station device 700. Signals and/or power sent between one or more elements may include, but not limited to, direct current (DC) power, control signals, reference signals, and/or feedback signals. In one embodiment of the present invention, an IF radio 705 may provide DC power to one or more BF modules 702 through one or more cables 703. In another embodiment of the present invention, one or more IF radios 705 may send control and reference signals through one or more cables 703 to one or more BF modules 702. BF modules 702 may send feedback signals back to IF radios 705 through cables 703.

It may be appreciated by a person with ordinary skill in the art that one or more elements of DPA-MIMO system based virtual reality base station device 700 may be combined into a single functional group or separated into a plurality of functional groups. In one embodiment of the present invention, a plurality of sets each comprising of an IF radio 705, a cable 703, and a BF module 702 may work individual functions such as, but not limited to, communications at a specific frequency, communications in a specific data stream, transmitting signals, and/or receiving signals. In another embodiment of the present invention, a plurality of sets comprising of one or more IF radios 705, cables 703, and BF modules 702 may work a single function such as, but not limited to, communications at a specific frequency, communications in a specific data stream, transmitting signals, and/or receiving signals.

It may be appreciated by a person with ordinary skill in the art that one or more BF modules 702 may cover a wide frequency range. A frequency range covered by one or more BF modules 702 may include, but not limited to, WiFi bands above 6 GHz, wireless gigabit (WiGig) bands from 57-71 GHz, and/or frequencies used by other wireless standards, licensed and unlicensed spectrum frequencies.

It may be appreciated by a person with ordinary skill in the art that virtual reality base station device housing 701 includes one or more processors that may perform any type of process and/or algorithm on electronic signals. Processes and/or algorithms include, but are not limited to, digital beamforming techniques that process one or more signals from the one or more BF modules 702 independently or jointly. BF modules 702 may also perform functions such as, but not limited to, removing interferences and/or enhancing a single to noise ratio of the one or more processed signals and/or signals between antenna elements within one BF module 702.

It may be appreciated by a person with ordinary skill in the art that a DPA-MIMO system based virtual reality base station device 700 may be for any wireless communication standard. Wireless communication standards include, but not limited to, the 2^{nd} Generation cellular system (2G), the 3^{rd} Generation cellular system (3G), the 4^{th} Generation cellular system (4G), the 5^{th} Generation cellular system (5G), WLAN, Bluetooth, and/or other wireless standards. In one embodiment of the present invention, a DPA-MIMO system based virtual reality base station device 700 may function at Bluetooth, NFC, and 3G/4G/5G wireless standards.

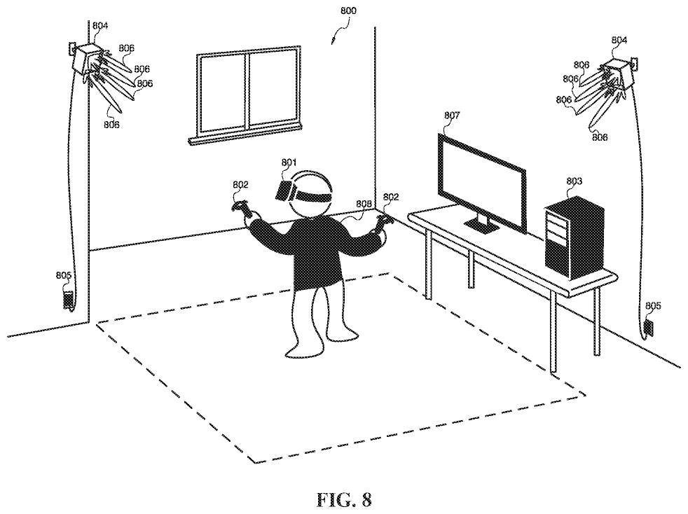

FIG. 8 illustrates a detailed perspective of an exemplary of a virtual reality application scenario with distributed phased arrays multiple-input-multiple-output system based systems, in accordance with an embodiment of the present invention. A DPA-MIMO wireless communication systems based virtual reality application scenario 800 comprises of one or more wearable virtual reality devices 801, one or more system controllers 802, one or more central processing systems 803, one or more virtual reality base station devices 804, one or more power suppliers of virtual reality base station devices 805, one or more radiation beams 806, one or more display devices 807, and one or more users 808. Wearable virtual reality devices 801 may be configured to receive and/or transmit wireless data. System controllers 802 may be configured to control one or more virtual reality base station devices 804, one or more power suppliers of virtual reality base station devices 805, one or more radiation beams 806, and one or more display devices 807. Central processing systems 803 process wireless/wired data of one or more wearable virtual reality devices 801, wireless/wired signals of system controllers 802, wireless/wired data of one or more virtual reality base station devices 804, and wireless/wired display signals of one or more display devices 807. Virtual reality base station devices 804 may be configured to receive and/or transmit wireless data. Power suppliers 805 may be configured to transform the alternating current of city electricity to direct current for powering virtual reality base station devices 804. Power suppliers 805 may comprise of energy storage devices. Display devices 807 may process and display the wireless/wired data from wearable virtual reality devices 801, system controllers 802, central processing systems 803, and virtual reality base station devices 804.

It may be appreciated by a person with ordinary skill in the art that one or more radiation beams 806 may originate from any wireless communication device. Wireless communication devices may include, but not limited to, one or more wearable virtual reality devices 801, one or more system controllers 802, one or more central processing systems 803, one or more virtual reality base station devices 804, one or more display devices 807, and/or other devices capable of transmitting wireless signals.

It may be appreciated by a person with ordinary skill in the art that wireless data of virtual reality base station devices 804 may comprise of one or more radiation beams. Virtual reality base station devices 804 may be configured to be synchronized for transmitting/receiving wireless data. Virtual reality base station devices 804 may he configured to be installed in different locations in a distributed manner.

It may be appreciated by a person with ordinary skill in the art that one or more system controllers 802 may be different types of controllers and/or sensors. One or more system controllers 802 may include, but not limited to, cameras, pressure sensors, proximity sensors, GPS, wireless controllers, motion gestures, and/or personal computing devices. In one embodiment of the present invention, one or more system controllers 802 include mounted cameras and motion gestures to provide one or more users 808 a physical controller-less virtual reality experience.

It may be appreciated by a person with ordinary skill in the art that virtual reality application scenario 800 may be applied to any physical environment. Physical environments may include, but not limited to, auditoriums, theaters, shopping malls, college campuses, parks, and/or warehouses. In one embodiment of the present invention, a reality application scenario 800 may be applied to an outdoor shopping mall, comprising of one or more users 808 wearing one or more wearable virtual reality devices 801 and one or more system controllers 802, central processing systems 803, virtual reality base station devices 804, and/or display devices 807 to create a virtual reality experience covering an entire area.

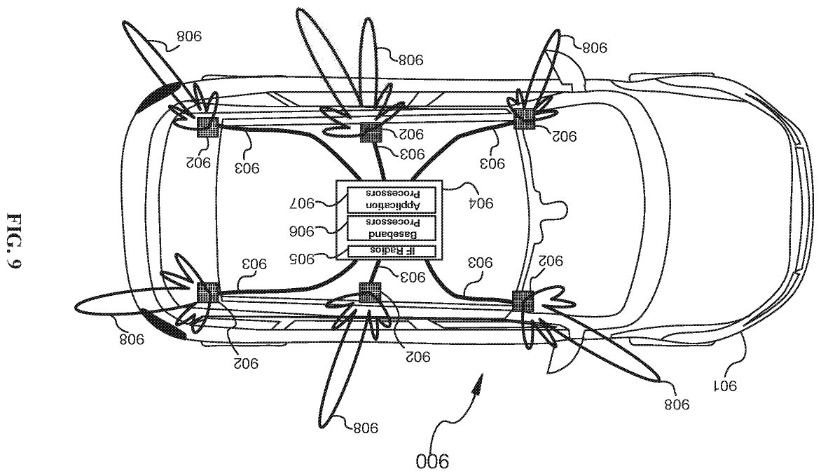

FIG. 9 illustrates a detailed perspective of an exemplary distributed phased arrays multiple-input-multiple-output system based vehicle system with multiple radiation beams, in accordance with an embodiment of the present invention. A DPA-MIMO system based automotive vehicle system 900 comprises of an automotive vehicle body and chassis 901, one or more BF modules 902, one or more cables 903, one or more main logic boards 904, one or more intermediate frequency (IF) radios 905, one or more baseband processors 906, one or more application processors 907, and one or more radiation beams 908. Application processors 907 may handle all baseband signals from baseband processors 906. Baseband processors 906 may handle all baseband signals for all IF radios 905. Electronic signals and/or power may travel from one or more main logic boards 904 through one or more cables 903 to one or more BF modules 902. BF module 902 may be configured to receive and/or transmit wireless data. One or more BF modules 902 may be placed on/in the device in a distributed way.

During a typical receive operation, henceforth also known as a downlink path, BF module 902 receives wireless signals and downconverts the wireless signals to an intermediate frequency (IF) range. One or more BF modules 902 may form wireless receiving beams independently or jointly pointing to any directions with any beamwidths that are amenable to reception in a given propagation environment. The wireless signals in the IF range are sent through one or more cables 903 to one or more main logic boards 904. At IF radios 905, IF range wireless signals are further downconverted in the frequency domain and sent to baseband processors 906 for processing. At application processors 907, baseband signals are further processed for application purposes.

During a typical transmit operation, henceforth also known as an uplink path, baseband processors 906 process application-layer signals from application processors 907 and generate baseband data carrying information for communication and send the baseband signals to one or more IF radios 905. IF radios 905 upconvert the baseband signals to one or more intermediate frequencies which are sent through one or more cables 903 to one or more BF modules 902. BF modules 902 upconvert any received IF signals to one or more predetermined transmission frequencies. One or more BF modules 902 further form one or more wireless transmission beams independently or jointly pointing to any directions with any beamwidths that are amenable to transmission in a given propagation environment and sends wireless signals at transmission frequencies.

One or more IF radios 905 may be connected to one or more BF modules 902 through one or more cables 903. BF modules 902 may exchange IF signals with a plurality of IF radios 905, which may be performed during instances when, but not limited to, some of the BF modules are powered down or stand by.

It may be appreciated by a person with ordinary skill in the art that baseband processors 906 include a processor that may perform any type of process and/or algorithm on electronic signals. Processes and/or algorithms include, but are not limited to, digital beamforming techniques that process one or more signals from the one or more BF modules 902 independently or jointly. Digital beamforming may implement functions such as, but not limited to, removing interferences and/or enhancing a signal-to-noise ratio of the one or more processed signals and/or signals between antenna elements within one BF module 902. Baseband processors 902 may also perform baseband processing for other wireless protocols and/or standards. Baseband processors 902 may also perform baseband processing for radar signal processing used for, but not limited to, autonomous driving.

It may be appreciated by a person with ordinary skill in the art that one or more cables 903 may be any type of medium capable of sending signals and/or power. Cables 903 may be, but not limited to, fiber optic cables, coaxial cables, IPEX/IPX cables, and/or ethernet cables with the any necessary coupling apparent by a person with ordinary skill in the art. In one embodiment of the present invention, cables 903 may be fiber optic cables carrying signals and/or power at various optical wavelengths.

It may be appreciated by a person with ordinary skill in the art that one or more cables 903 may carry signals at one or more frequencies for each cable 903. In one embodiment of the present invention a single cable 903 may carry multiple signals at a plurality of frequencies.

It may be appreciated by a person with ordinary skill in the art that a BF module 902 may include any type of beamforming antenna in any orientation. BF module 902 antennas may include, but not limited to, phased array antennas, steerable antennas, and/or reconfigurable antennas. In one embodiment of the present invention, a plurality of phased array antennas are orientated in a circular formation. In another embodiment of the present invention, a plurality of phased array antennas are orientated in a stacked up three-dimensional formation.

It may be appreciated by a person with ordinary skill in the art that a BF module 902 may operate at any frequency range. Frequency ranges may be, but not limited to, from 1 GHz to 10 THz, to handle various wireless technologies and standards which may include, but not limited to, cellular communications, wireless local area network (WLAN) communications, global navigation satellite system (GNSS) communications, millimeter wave (mmWave) communications, satellite communications, vehicle communications, radar sensing, remote sensing, terahertz (THz) communications, visible-light communications, near field communications (NFC) and/or other wireless communications. In one embodiment of the present invention, a plurality of BF modules 902 may cover a plurality of standard wireless communications frequencies such that a DPA-MIMO wireless communications system based vehicle 900 may function at a plurality of wireless communication protocols.

It may be appreciated by a person with ordinary skill in the art that any signal and/or power may be sent between one or more elements of DPA-MIMO system based vehicle 900. Signals and/or power sent between one or more elements may include, but not limited to, direct current (DC) power, control signals, reference signals, and/or feedback signals. In one embodiment of the present invention, an IF radio 905 may provide DC power to one or more BF modules 902 through one or more cables 903. In another embodiment of the present invention, one or more IF radios 905 may send control and reference signals through one or more cables 903 to one or more BF modules 902. BF modules 902 may send feedback signals back to IF radios 905 through cables 903.

It may be appreciated by a person with ordinary skill in the art that one or more elements of DPA-MIMO system based vehicle 900 may be combined into a single functional group or separated into a plurality of functional groups. In one embodiment of the present invention, a plurality of sets each comprising of an IF radio 905, a cable 903, and a BF module 902 may work individual functions such as, but not limited to, communications at a specific frequency, communications in a specific data stream, transmitting signals, and/or receiving signals. In another embodiment of the present invention, a plurality of sets comprising of one or more IF radios 905, cables 903, and BF modules 902 may work a single function such as, but not limited to, communications at a specific frequency, communications in a specific data stream, transmitting signals, and/or receiving signals.

It may be appreciated by a person with ordinary skill in the art that one or more BF modules 902 may cover a wide frequency range. A frequency range covered by one or more BF modules 902 may include, but not limited to, WiFi bands above 6 GHz, wireless gigabit (WiGig) bands from 57-71 GHz, 76-81 GHz for radar services, and/or frequencies used by other wireless standards, licensed and unlicensed spectrum frequencies.

It may be appreciated by a person with ordinary skill in the art that an automotive vehicle body and chassis 901 includes one or more processors that may perform any type of process and/or algorithm on electronic signals. Processes and/or algorithms include, but are not limited to, digital beamforming techniques that process one or more signals from the one or more BF modules 902 independently or jointly. BF modules 902 may also perform functions such as, but not limited to, removing interferences and/or enhancing a single to noise ratio of the one or more processed signals and/or signals between antenna elements within one BF module 902.

It may be appreciated by a person with ordinary skill in the art that such a DPA-MIMO system based vehicle 900 may be for any wireless communication standard. Wireless communication standards include, but not limited to, the 2^{nd} Generation cellular system (2G), the 3^{rd} Generation cellular system (3G), the 4^{th} Generation cellular system (4G), the 5^{th} Generation cellular system (5G), WLAN, Bluetooth, satellite communication, radar communication, and/or other wireless standards. In one embodiment of the present invention, 900 may function at Bluetooth, NFC, and 3G/4G/5G wireless standards.

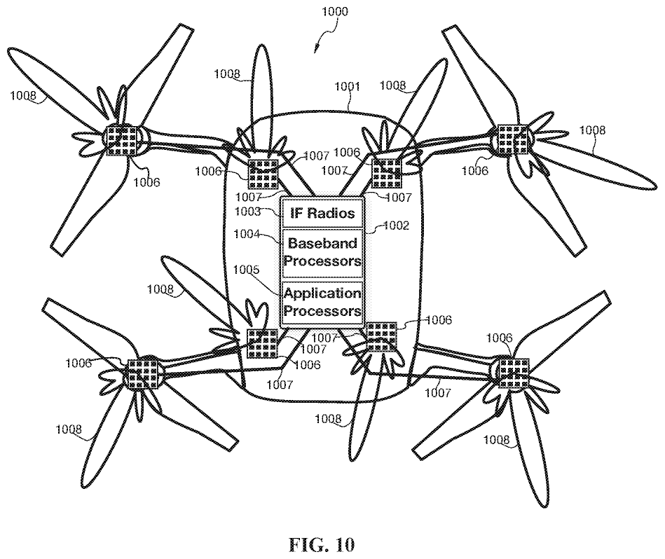

FIG. 10 illustrates a detailed perspective of an exemplary distributed phased arrays multiple-input-multiple-output system based rotary-wing unmanned aerial vehicle system with multiple radiation beams, in accordance with an embodiment of the present invention. A DPA-MIMO system based rotary-wing unmanned aerial vehicle system 1000 comprises of a rotary-wing unmanned aerial vehicle body and chassis 1001, one or more main logic boards 1002, one or more intermediate frequency (IF) radios 1003, one or more baseband processors 1004, one or more application processors 1005, one or more BF modules 1006, one or more cables 1007, and one or more radiation beams 1008. Application processors 1005 may handle all baseband signals from baseband processors 1004. Baseband processors 1004 may handle all baseband signals for all IF radios 1003. Electronic signals and/or power may travel from one or more main logic boards 1002 through one or more cables 1007 to one or more BF modules 1006. BF module 1006 may be configured to receive and/or transmit wireless data. One or more BF modules 1006 may be placed on/in the device in a distributed way.

During a typical receive operation, henceforth also known as a downlink path, BF module 1006 receives wireless signals and downconverts the wireless signals to an intermediate frequency (IF) range. One or more BF modules 1006 may form wireless receiving beams independently or jointly pointing to any directions with any beamwidths that are amenable to reception in a given propagation environment. The wireless signals in the IF range are sent through one or more cables 1007 to one or more main logic boards 1002. At IF radios 1003, IF range wireless signals are further downconverted in the frequency domain and sent to baseband processors 1004 for processing. At application processors 1005, baseband signals are further processed for application purposes.

During a typical transmit operation, henceforth also known as an uplink path, baseband processors 1004 process application-layer signals from application processors 1005 and generate baseband data carrying information for communication and send the baseband signals to one or more IF radios 1003. IF radios 1003 upconvert the baseband signals to one or more intermediate frequencies which are sent through one or more cables 1007 to one or more BF modules 1006. BF modules 1006 upconvert any received IF signals to one or more predetermined transmission frequencies. One or more BF modules 1006 further form one or more wireless transmission beams independently or jointly pointing to any directions with any beamwidths that are amenable to transmission in a given propagation environment and sends wireless signals at transmission frequencies.

One or more IF radios 1003 may be connected to one or more BF modules 1006 through one or more cables 1007. BF modules 1006 may exchange IF signals with a plurality of IF radios 1003, which may be performed during instances when, but not limited to, some of the BF modules are powered down or stand by.

It may be appreciated by a person with ordinary skill in the art that baseband processors 1004 include a processor that may perform any type of process and/or algorithm on electronic signals. Processes and/or algorithms include, but are not limited to, digital beamforming techniques that process one or more signals from the one or more BF modules 1006 independently or jointly. Digital beamforming may implement functions such as, but not limited to, removing interferences and/or enhancing a signal-to-noise ratio of the one or more processed signals and/or signals between antenna elements within one BF module 1006. Baseband processors 1006 may also perform baseband processing for other wireless protocols and/or standards. Baseband processors 1006 may also perform baseband processing for radar signal processing used for, but not limited to, autonomous driving.

It may be appreciated by a person with ordinary skill in the art that one or more cables 1007 may be any type of medium capable of sending signals and/or power. Cables 1007 may be, but not limited to, fiber optic cables, coaxial cables, IPEX/IPX cables, and/or ethernet cables with the any necessary coupling apparent by a person with ordinary skill in the art. In one embodiment of the present invention, cables 1007 may be fiber optic cables carrying signals and/or power at various optical wavelengths.

It may be appreciated by a person with ordinary skill in the art that one or more cables 1007 may carry signals at one or more frequencies for each cable 1007. In one embodiment of the present invention a single cable 1007 may carry multiple signals at a plurality of frequencies.

It may be appreciated by a person with ordinary skill in the art that a BF module 1006 may include any type of beamforming antenna in any orientation. BF module 1006 antennas may include, but not limited to, phased array antennas, steerable antennas, and/or reconfigurable antennas. In one embodiment of the present invention, a plurality of phased array antennas are orientated in a circular formation. In another embodiment of the present invention, a plurality of phased array antennas are orientated in a stacked up three-dimensional formation.

It may be appreciated by a person with ordinary skill in the art that a BF module 1006 may operate at any frequency range. Frequency ranges may be, but not limited to, from 1 GHz to 10 THz, to handle various wireless technologies and standards which may include, but not limited to, cellular communications, wireless local area network (WLAN) communications, global navigation satellite system (GNSS) communications, millimeter wave (mmWave) communications, satellite communications, vehicle communications, radar sensing, remote sensing, terahertz (THz) communications, visible-light communications, near field communications (NFC) and/or other wireless communications. In one embodiment of the present invention, a plurality of BF modules 1006 may cover a plurality of standard wireless communications frequencies such that a DPA-MIMO wireless communications system based rotary-wing unmanned aerial vehicle 1000 may function at a plurality of wireless communication protocols.

It may be appreciated by a person with ordinary skill in the art that any signal and/or power may be sent between one or more elements of DPA-MIMO system based rotary-wing unmanned aerial vehicle 1000. Signals and/or power sent between one or more elements may include, but not limited to, direct current (DC) power, control signals, reference signals, and/or feedback signals. In one embodiment of the present invention, an IF radio 1003 may provide DC power to one or more BF modules 1006 through one or more cables 1007. In another embodiment of the present invention, one or more IF radios 1003 may send control and reference signals through one or more cables 1007 to one or more BF modules 1006. BF modules 1006 may send feedback signals back to IF radios 1003 through cables 1007.

It may be appreciated by a person with ordinary skill in the art that one or more elements of a DPA-MIMO system based rotary-wing unmanned aerial vehicle 1000 may be combined into a single functional group or separated into a plurality of functional groups. In one embodiment of the present invention, a plurality of sets each comprising of an IF radio 1003, a cable 1007, and a BF module 1006 may work individual functions such as, but not limited to, communications at a specific frequency, communications in a specific data stream, transmitting signals, and/or receiving signals. In another embodiment of the present invention, a plurality of sets comprising of one or more IF radios 1003, cables 1007, and BF modules 1006 may work a single function such as, but not limited to, communications at a specific frequency, communications in a specific data stream, transmitting signals, and/or receiving signals.

It may be appreciated by a person with ordinary skill in the art that one or more BF modules 1006 may cover a wide frequency range. A frequency range covered by one or more BF modules 1006 may include, but not limited to, WiFi bands above 6 GHz, wireless gigabit (WiGig) bands from 57-71 GHz, 76-81 GHz for radar services, and/or frequencies used by other wireless standards, licensed and unlicensed spectrum frequencies.

It may be appreciated by a person with ordinary skill in the art that a rotary-wing unmanned aerial vehicle body and chassis 1001 includes one or more processors that may perform any type of process and/or algorithm on electronic signals. Processes and/or algorithms include, but are not limited to, digital beamforming techniques that process one or more signals from the one or more BF modules 1006 independently or jointly. BF modules 1006 may also perform functions such as, but not limited to, removing interferences and/or enhancing a single to noise ratio of the one or more processed signals and/or signals between antenna elements within one BF module 1006.

It may be appreciated by a person with ordinary skill in the art that a DPA-MIMO system based rotary-wing unmanned aerial vehicle system 1000 may be for any wireless communication standard. Wireless communication standards include, but not limited to, the 2^{nd} Generation cellular system (2G), the 3^{rd} Generation cellular system (3G), the 4^{th} Generation cellular system (4G), the 5^{th} Generation cellular system (5G), WLAN, Bluetooth, satellite communication, radar communication, and/or other wireless standards. In one embodiment of the present invention, a DPA-MIMO system based rotary-wing unmanned aerial vehicle system 1000 may function at Bluetooth, NFC, and 3G/4G/5G wireless standards.

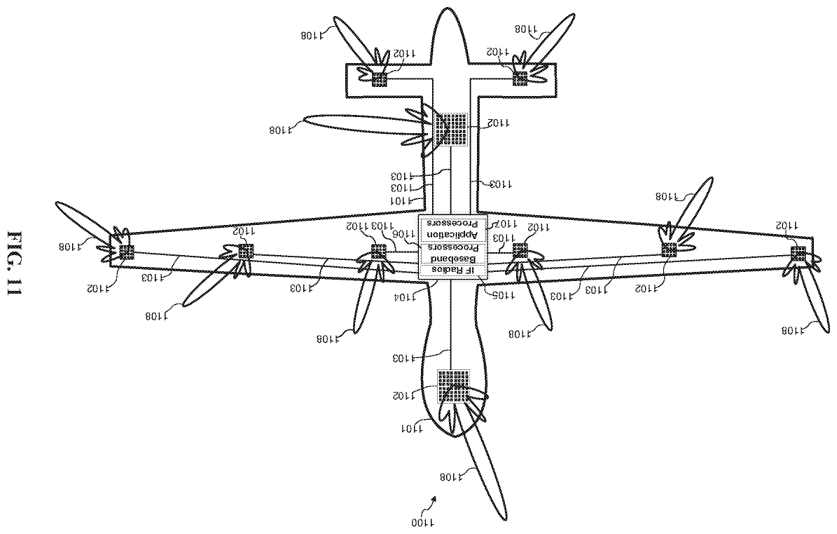

FIG. 11 illustrates a detailed perspective of an exemplary distributed phased arrays multiple-input-multiple-output system based fixed-wing unmanned aerial vehicle system with multiple radiation beams, in accordance with an embodiment of the present invention. A DPA-MIMO system based fixed-wing unmanned aerial vehicle system 1100 comprises of a fixed-wing unmanned aerial vehicle body and chassis 1101, one or more BF modules 1102, one or more cables 1103, one or more main logic boards 1104, one or more intermediate frequency (IF) radios 1105, one or more baseband processors 1106, one or more application processors 1107, and one or more radiation beams 1108. Application processors 1107 may handle all baseband signals from baseband processors 1106. Baseband processors 1106 may handle all baseband signals for all IF radios 1105. Electronic signals and/or power may travel from one or more main logic boards 1104 through one or more cables 1103 to one or more BF modules 1102. BF module 1102 may be configured to receive and/or transmit wireless data. One or more BF modules 1102 may be placed on/in the device in a distributed way.

During a typical receive operation, henceforth also known as a downlink path, BF module 1102 receives wireless signals and downconverts the wireless signals to an intermediate frequency (IF) range. One or more BF modules 1102 may form wireless receiving beams independently or jointly pointing to any directions with any beamwidths that are amenable to reception in a given propagation environment. The wireless signals in the IF range are sent through one or more cables 1103 to one or more main logic boards 1104. At IF radios 1105, IF range wireless signals are further downconverted in the frequency domain and sent to baseband processors 1106 for processing. At application processors 1107, baseband signals are further processed fur application purposes.

During a typical transmit operation, henceforth also known as an uplink path, baseband processors 1106 process application-layer signals from application processors 1107 and generate baseband data carrying information for communication and send the baseband signals to one or more IF radios 1105. IF radios 1105 upconvert the baseband signals to one or more intermediate frequencies which are sent through one or more cables 1103 to one or more BF modules 1102. BF modules 1102 upconvert any received IF signals to one or more predetermined transmission frequencies. One or more BF modules 1102 further form one or more wireless transmission beams independently or jointly pointing to any directions with any beamwidths that are amenable to transmission in a given propagation environment and sends wireless signals at transmission frequencies.

One or more IF radios 1105 may be connected to one or more BF modules 1102 through one or more cables 1103. BF modules 1102 may exchange IF signals with a plurality of IF radios 1105, which may be performed during instances when, but not limited to, some of the BF modules are powered down or stand by.

It may be appreciated by a person with ordinary skill in the art that baseband processors 1106 include a processor that may perform any type of process and/or algorithm on electronic signals. Processes and/or algorithms include, but are not limited to, digital beamforming techniques that process one or more signals from the one or more BF modules 1102 independently or jointly. Digital beamforming may implement functions such as, but not limited to, removing interferences and/or enhancing a signal-to-noise ratio of the one or more processed signals and/or signals between antenna elements within one BF module 1102. Baseband processors 1106 may also perform baseband processing for other wireless protocols and/or standards. Baseband processors 1106 may also perform baseband processing for radar signal processing used for, but not limited to, autonomous driving.

It may be appreciated by a person with ordinary skill in the art that one or more cables 1103 may be any type of medium capable of sending signals and/or power. Cables 1103 may be, but not limited to, fiber optic cables, coaxial cables, IPEX/IPX cables, and/or ethernet cables with the any necessary coupling apparent by a person with ordinary skill in the art. In one embodiment of the present invention, cables 1103 may be fiber optic cables carrying signals and/or power at various optical wavelengths.

It may be appreciated by a person with ordinary skill in the art that one or more cables 1103 may carry signals at one or more frequencies for each cable 1103. In one embodiment of the present invention a single cable 1103 may carry multiple signals at a plurality of frequencies.

It may be appreciated by a person with ordinary skill in the art that a BF module 1102 may include any type of beamforming antenna in any orientation. BF module 1102 antennas may include, but not limited to, phased array antennas, steerable antennas, and/or reconfigurable antennas. In one embodiment of the present invention, a plurality of phased array antennas are orientated in a circular formation. In another embodiment of the present invention, a plurality of phased array antennas are orientated in a stacked up three-dimensional formation.

It may be appreciated by a person with ordinary skill in the art that a BF module 1102 may operate at any frequency range. Frequency ranges may be, but not limited to, from 1 GHz to 10 THz, to handle various wireless technologies and standards which may include, but not limited to, cellular communications, wireless local area. network (WLAN) communications, global navigation satellite system (GNSS) communications, millimeter wave (mmWave) communications, satellite communications, vehicle communications, radar sensing, remote sensing, terahertz (THz) communications, visible-light communications, near field communications (NFC) and/or other wireless communications. In one embodiment of the present invention, a plurality of BF modules 1102 may cover a plurality of standard wireless communications frequencies such that a DPA-MIMO wireless communications system based fixed-wing unmanned aerial vehicle 1100 may function at a plurality of wireless communication protocols.

It may be appreciated by a person with ordinary skill in the art that any signal and/or power may be sent between one or more elements of DPA-MIMO system based fixed-wing unmanned aerial vehicle 1100. Signals and/or power sent between one or more elements may include, but not limited to, direct current (DC) power, control signals, reference signals, and/or feedback signals. In one embodiment of the present invention, an IF radio 1105 may provide DC power to one or more BF modules 1102 through one or more cables 1103. In another embodiment of the present invention, one or more IF radios 1105 may send control and reference signals through one or more cables 1103 to one or more BF modules 1102. BF modules 1102 may send feedback signals back to IF radios 1105 through cables 1103.

It may be appreciated by a person with ordinary skill in the art that one or more elements of a DPA-MIMO system based fixed-wing unmanned aerial vehicle ith multiple radiation beams 1100 may be combined into a single functional group or separated into a plurality of functional groups. In one embodiment of the present invention, a plurality of sets each comprising of an IF radio 1105, a cable 1103, and a BF module 1102 may work individual functions such as, but not limited to, communications at a specific frequency, communications in a specific data stream, transmitting signals, and/or receiving signals. In another embodiment of the present invention, a plurality of sets comprising of one or more IF radios 1105, cables 1103, and BF modules 1102 may work a single function such as, but not limited to, communications at a specific frequency, communications in a specific data stream, transmitting signals, and/or receiving signals.

It may be appreciated by a person with ordinary skill in the art that one or more BF modules 1102 may cover a wide frequency range. A frequency range covered by one or more BF modules 1102 may include, but not limited to, WiFi bands above 6 GHz, wireless gigabit (WiGig) bands from 57-71 GHz, 76-81 GHz for radar services, and/or frequencies used by other wireless standards, licensed and unlicensed spectrum frequencies.

It may be appreciated by a person with ordinary skill in the art that a fixed-wing unmanned aerial vehicle body and chassis 1101 includes one or more processors that may perform any type of process and/or algorithm on electronic signals. Processes and/or algorithms include, but are not limited to, digital beamforming techniques that process one or more signals from the one or more BF modules 1102 independently or jointly. BF modules 1102 may also perform functions such as, but not limited to, removing interferences and/or enhancing a single to noise ratio of the one or more processed signals and/or signals between antenna elements within one BF module 1102.

It may be appreciated by a person with ordinary skill in the art that such a DPA-MIMO system based fixed-wing unmanned aerial vehicle system 1100 may be for any wireless communication standard. Wireless communication standards include, but not limited to, the 2^{nd} Generation cellular system (2G), the 3^{th} Generation cellular system (3G), the 4^{th} Generation cellular system (4G), the 5^{th} Generation cellular system (5G), WLAN, Bluetooth, satellite communication, radar communication, and/or other wireless standards. in one embodiment of the present invention. 1100 may function at Bluetooth, NFC, and 3G/4G/5G wireless standards.

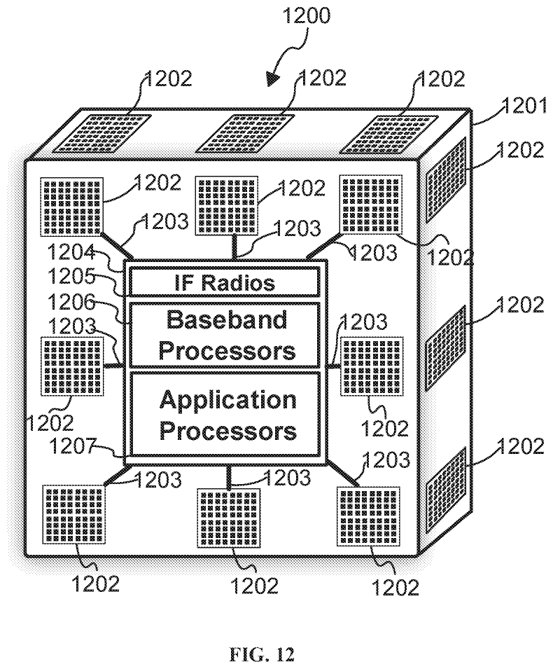

FIG. 12 illustrates a detailed perspective of an exemplary distributed phased arrays multiple-input-multiple-output system based communication box for high altitude platform (HAP), in accordance with an embodiment of the present invention. A DPA-MIMO system based HAP communication box 1200 comprises of a communication box case/housing/frame 1201, one or more BF modules 1202, one or more cables 1203, one or more main logic boards 1204, one or more intermediate frequency (IF) radios 1205, one or more baseband processors 1206, one or more application processors 1207, and one or more radiation beams 1208. Application processors 1207 may handle all baseband signals from baseband processors 1206. Baseband processors 1206 may handle all baseband signals for all IF radios 1205. Electronic signals and/or power may travel from one or more main logic boards 1204 through one or more cables 1203 to one or more BF modules 1202. BF module 1202 may be configured to receive and/or transmit wireless data. One or more BF modules 1202 may be placed on/in the device in a distributed way.

During a typical receive operation, henceforth also known as a downlink path, BF module 1202 receives wireless signals and downconverts the wireless signals to an intermediate frequency (IF) range. One or more BF modules 1202 may form wireless receiving beams independently or jointly pointing to any directions with any beamwidths that are amenable to reception in a given propagation environment. The wireless signals in the IF range are sent through one or more cables 1203 to one or more main logic boards 1204. At IF radios 1205, IF range wireless signals are further downconverted in the frequency domain and sent to baseband processors 1206 for processing. At application processors 1207, baseband signals are further processed for application purposes.

During a typical transmit operation, henceforth also known as an uplink path, baseband processors 1206 process application-layer signals from application processors 1207 and generate baseband data carrying information for communication and send the baseband signals to one or more IF radios 1205. IF radios 1205 upconvert the baseband signals to one or more intermediate frequencies which are sent through one or more cables 1203 to one or more BF modules 1202. BF modules 1202 upconvert any received IF signals to one or more predetermined transmission frequencies. One or more BF modules 1202 further form one or more wireless transmission beams independently or jointly pointing to any directions with any beamwidths that are amenable to transmission in a given propagation environment and sends wireless signals at transmission frequencies.

One or more IF radios 1205 may be connected to one or more BF modules 1202 through one or more cables 1203. BF modules 1202 may exchange IF signals with a plurality of IF radios 1205, which may be performed during instances when, but not limited to, some of the BF modules are powered down or stand by.

It may be appreciated by a person with ordinary skill in the art that baseband processors 1206 include a processor that may perform any type of process and/or algorithm on electronic signals. Processes and/or algorithms include, but are not limited to, digital beamforming techniques that process one or more signals from the one or more BF modules 1202 independently or jointly. Digital beamforming may implement functions such as, but not limited to, removing interferences and/or enhancing a signal-to-noise ratio of the one or more processed signals and/or signals between antenna elements within one BF module 1202. Baseband processors 1206 may also perform baseband processing for other wireless protocols and/or standards. Baseband processors 1206 may also perform baseband processing for radar signal processing used for, but not limited to, autonomous driving.

It may be appreciated by a person with ordinary skill in the art that one or more cables 1203 may be any type of medium capable of sending signals and/or power. Cables 1203 may be, but not limited to, fiber optic cables, coaxial cables, IPEX/IPX cables, and/or ethernet cables with the any necessary coupling apparent by a person with ordinary skill in the art. In one embodiment of the present invention, cables 1203 may be fiber optic cables carrying signals and/or power at various optical wavelengths.

It may be appreciated by a person with ordinary skill in the art that one or more cables 1203 may carry signals at one or more frequencies for each cable 1203. In one embodiment of the present invention a single cable 1203 may carry multiple signals at a plurality of frequencies.

It may be appreciated by a person with ordinary skill in the art that a BF module 1202 may include any type of beamforming antenna in any orientation. BF module 1202 antennas may include, but not limited to, phased array antennas, steerable antennas, and/or reconfigurable antennas. In one embodiment of the present invention, a plurality of phased array antennas are orientated in a circular formation. In another embodiment of the present invention, a plurality of phased array antennas are orientated in a stacked up three-dimensional formation,

It may be appreciated by a person with ordinary skill in the art that a BF module 1202 may operate at any frequency range. Frequency ranges may be, but not limited to, from 1 GHz to 10 THz, to handle various wireless technologies and standards which may include, but not limited to, cellular communications, wireless local area network (WLAN) communications, global navigation satellite system (GNSS) communications, millimeter wave (mmWave) communications, satellite communications, vehicle communications, radar sensing, remote sensing, terahertz (THz) communications, visible-light communications, near field communications (NFC) and/or other wireless communications. In one embodiment of the present invention, a plurality of BF modules 1202 may cover a plurality of standard wireless communications frequencies such that a DPA-MIMO wireless communications system based HAP communication box 1200 may function at a plurality of wireless communication protocols.

It may be appreciated by a person with ordinary skill in the art that any signal and/or power may be sent between one or more elements of DPA-MIMO system based HAP communication box. Signals and/or power sent between one or more elements may include, but not limited to, direct current (DC) power, control signals, reference signals, and/or feedback signals. In one embodiment of the present invention, an IF radio 1205 may provide DC power to one or more BF modules 1202 through one or more cables 1203. In another embodiment of the present invention, one or more IF radios 1205 may send control and reference signals through one or more cables 1203 to one or more BF modules 1202. BF modules 1202 may send feedback signals back to IF radios 1205 through cables 1203.

It may be appreciated by a person with ordinary skill in the art that one or more elements of a DPA-MIMO system based HAP communication box 1200 may be combined into a single functional group or separated into a plurality of functional groups. In one embodiment of the present invention, a plurality of sets each comprising of an IF radio 1205, a cable 1203, and a BF module 1202 may work individual functions such as, but not limited to, communications at a specific frequency, communications in a specific data stream, transmitting signals, and/or receiving signals. In another embodiment of the present invention, a plurality of sets comprising of one or more IF radios 1205, cables 1203, and BF modules 1202 may work a single function such as, but not limited to, communications at a specific frequency, communications in a specific data stream, transmitting signals, and/or receiving signals.

It may be appreciated by a person with ordinary skill in the art that one or more BF modules 1202 may cover a wide frequency range. A frequency range covered by one or more BF modules 1202 may include, but not limited to, WiFi bands above 6 GHz, wireless gigabit (WiGig) bands from 57-71 GHz, 76-81 GHz for radar services, and/or frequencies used by other wireless standards, licensed and unlicensed spectrum frequencies.

It may be appreciated by a person with ordinary skill in the art that a HAP communication box case/housing/frame 1201 includes one or more processors that may perform any type of process and/or algorithm on electronic signals. Processes and/or algorithms include, but are not limited to, digital beamforming techniques that process one or more signals from the one or more BF modules 1202 independently or jointly. BF modules 1202 may also perform functions such as, but not limited to, removing interferences and/or enhancing a single to noise ratio of the one or more processed signals and/or signals between antenna elements within one BF module 1202.

It may be appreciated by a person with ordinary skill in the art that such a DPA-MIMO system based HAP communication box case 1200 may be for any wireless communication standard. Wireless communication standards include, but not limited to, the 2^{nd} Generation cellular system (2G), the 3^{rd} Generation cellular system (3G), the 4^{th} Generation cellular system (4G), the 5^{th} Generation cellular system (5G), WLAN, Bluetooth, satellite communication, radar communication, and/or other wireless standards. In one embodiment of the present invention, 1200 may function at Bluetooth, NFC, and 3G/4G/5G wireless standards.

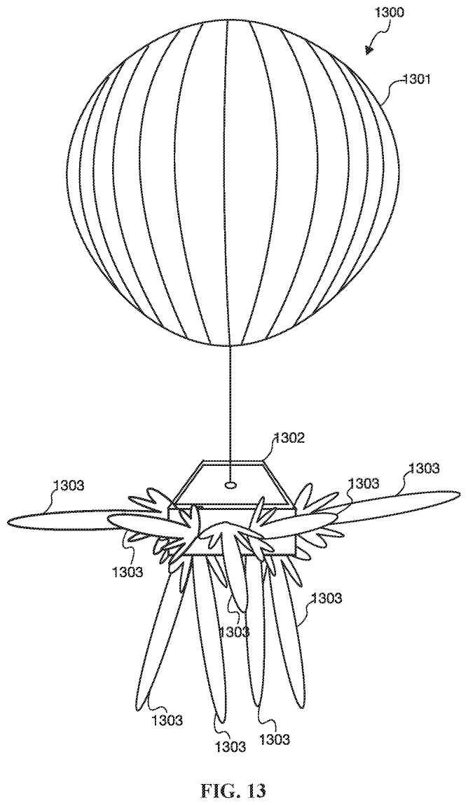

FIG. 13 illustrates a detailed perspective of an exemplary distributed phased arrays multiple-input-multiple-output system based high altitude platform communication system with multiple radiation beams, in accordance with an embodiment of the present invention. A DPA-MIMO system based HAP communication system 1300 comprises of one or more balloons 1301, one or more communication and payload boxes 1302, and one or more radiation beams 1303.

In an example embodiment, a balloon 1301 may be filled with hot air, and helium, hydrogen or other lighter-than-air material. A balloon 1301 could be also associated with propulsion of ionic wind. A balloon 1301 could be associated with energy harvesting materials and technology to transfer the natural energy including, but not limited to solar energy, wind energy, thermal energy, and/or artificial energy including, but not limited to, microwave energy and optical energy.

It may be appreciated by a person with ordinary skill in the art that one or more DPA-MIMO system based HAP communication system 1300 may be deployed and functioning at any altitude above the sea level, e.g., from 10 m to 60 km. A DPA-MIMO system based HAP communication system 1300 communicates with each other to form a local, regional, or global network. A DPA-MIMO system based HAP communication system 1300 communicates with other systems including but not limited to, terrestrial communication systems, marine/under-water communication systems, aerial communication systems, satellite communication systems, outer-space communication systems, and interstellar communication systems.

It may be appreciated by a person with ordinary skill in the art that a communication and payload box 1302 includes one or more processors that may perform any type of process and/or algorithm on electronic signals. Processes and/or algorithms include, but are not limited to, digital beamforming techniques that process one or more signals from the one or more BF modules independently or jointly.

It may be appreciated by a person with ordinary skill in the art that a communication and payload box 1302 could be associated with energy harvesting materials and technology to transfer the natural energy including, but not limited to solar energy, wind energy, thermal energy, and/or artificial energy including, but not limited to, microwave energy and optical energy.

It may be appreciated by a person with ordinary skill in the art that a communication and payload box 1302 may operate at any frequency range. Frequency ranges may be, but not limited to, from 1 GHz to 10 THz, to handle various wireless technologies and standards which may include, but not limited to, cellular communications, wireless local area network (WLAN) communications, global navigation satellite system (GNSS) communications, millimeter wave (mmWave) communications, satellite communications, vehicle communications, radar sensing, remote sensing, terahertz (THz) communications, visible-light communications, near field communications (NFC) and/or other wireless communications. In one embodiment of the present invention, a plurality of communication and payload boxes 1302 may cover a plurality of standard wireless communications frequencies such that the DPA-MIMO system based HAP communication system 1300 may function at a plurality of wireless communication protocols.

It may be appreciated by a person with ordinary skill in the art that a communication and payload box 1302 may be integrated to and/or mounted on any high-altitude device and/or vehicle. Communication and payload box 1302 may be integrated to and/or mounted on devices and/or vehicles including, but not limited to, satellites, skyscrapers, cellular towers, blimps, mountains, asteroids, and/or moons. In one embodiment of the present invention, communication and payload box 1302 is mounted onto a spaceship.

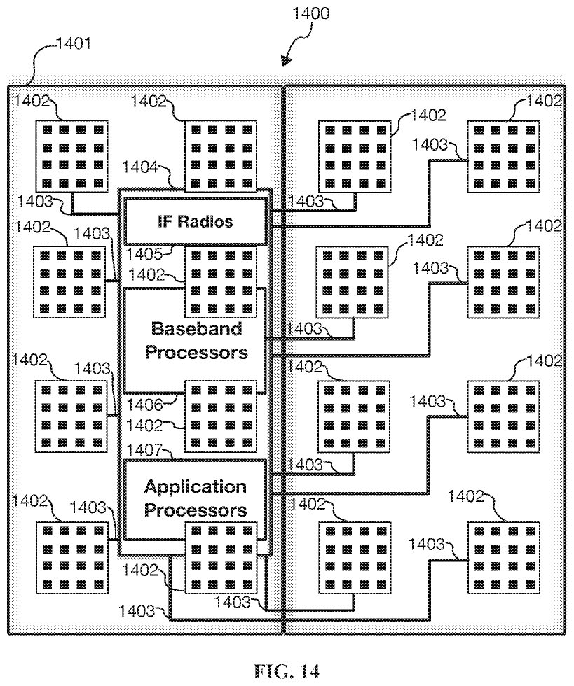

FIG. 14 illustrates a detailed perspective of an exemplary of an exemplary distributed phased arrays multiple-input-multiple-output system based foldable handheld device, in accordance with an embodiment of the present invention. A DPA-MIMO system based foldable handheld device 1400 comprises of a case/housing/frame of foldable handheld device 1401, one or more BF modules 1402, one or more cables 1403, one or more main logic boards 1404, one or more intermediate frequency (IF) radios 1405, one or more baseband processors 1406, one or more application processors 1407, and one or more radiation beams 1408. Application processors 1407 may handle all baseband signals from baseband processors 1406. Baseband processors 1406 may handle all baseband signals for all IF radios 1405. Electronic signals and/or power may travel from one or more main logic boards 1404 through one or more cables 1403 to one or more BF modules 1402. BF module 1402 may be configured to receive and/or transmit wireless data. One or more BF modules 1402 may be placed on/in the device in a distributed way.

During a typical receive operation, henceforth also known as a downlink path, BF module 1402 receives wireless signals and downconverts the wireless signals to an intermediate frequency (IF) range. One or more BF modules 1402 may form wireless receiving beams independently or jointly pointing to any directions with any beamwidths that are amenable to reception in a given propagation environment. The wireless signals in the IF range are sent through one or more cables 1403 to one or more main logic boards 1404. At IF radios 1405, IF range wireless signals are further downconverted in the frequency domain and sent to baseband processors 1406 for processing. At application processors 1407, baseband signals are further processed for application purposes.

During a typical transmit operation, henceforth also known as an uplink path, baseband processors 1406 process application-layer signals from application processors 1407 and generate baseband data carrying information for communication and send the baseband signals to one or more IF radios 1405. IF radios 1405 upconvert the baseband signals to one or more intermediate frequencies which are sent through one or more cables 1403 to one or more BF modules 1402. BF modules 1402 upconvert any received IF signals to one or more predetermined transmission frequencies. One or more BF modules 1402 further form one or more wireless transmission beams independently or jointly pointing to any directions with any beamwidths that are amenable to transmission in a given propagation environment and sends wireless signals at transmission frequencies.

One or more IF radios 1405 may be connected to one or more BF modules 1402 through one or more cables 1403. BF modules 1402 may exchange IF signals with a plurality of IF radios 1405, which may be performed during instances when, but not limited to, some of the BF modules are powered down or stand by.

It may be appreciated by a person with ordinary skill in the art that a case/housing/frame of foldable handheld device 1401 can be folded in between to any angle.

It may be appreciated by a person with ordinary skill in the art that baseband processors 1406 include a processor that may perform any type of process and/or algorithm on electronic signals. Processes and/or algorithms include, but are not limited to, digital beamforming techniques that process one or more signals from the one or more BF modules 1402 independently or jointly. Digital beamforming may implement functions such as, but not limited to, removing interferences and/or enhancing a signal-to-noise ratio of the one or more processed signals and/or signals between antenna elements within one BF module 1402. Baseband processors 1406 may also perform baseband processing for other wireless protocols and/or standards. Baseband processors 1406 may also perform baseband processing for radar signal processing used for, but not limited to, autonomous driving.

It may be appreciated by a person with ordinary skill in the art that one or more cables 1403 may be any type of medium capable of sending signals and/or power. Cables 1403 may be, but not limited to, fiber optic cables, coaxial cables, IPEX/IPX cables, and/or ethernet cables with the any necessary coupling apparent by a person with ordinary skill in the art. In one embodiment of the present invention, cables 1403 may be fiber optic cables carrying signals and/or power at various optical wavelengths.

It may be appreciated by a person with ordinary skill in the art that one or more cables 1403 may carry signals at one or more frequencies for each cable 1403. In one embodiment of the present invention a single cable 1403 may carry multiple signals at a plurality of frequencies.

It may be appreciated by a person with ordinary skill in the art that a BF module 1402 may include any type of beamforming antenna in any orientation. BF module 1402 antennas may include, but not limited to, phased array antennas, steerable antennas, and/or reconfigurable antennas. In one embodiment of the present invention, a plurality of phased array antennas are orientated in a circular formation. In another embodiment of the present invention, a plurality of phased array antennas are orientated in a stacked up three-dimensional formation.

It may be appreciated by a person with ordinary skill in the art that a BF module 1402 may operate at any frequency range. Frequency ranges may be, but not limited to, from 1 GHz to 10 THz, to handle various wireless technologies and standards which may include, but not limited to, cellular communications, wireless local area network (WLAN) communications, global navigation satellite system (GNSS) communications, millimeter wave (mmWave) communications, satellite communications, vehicle communications, radar sensing, remote sensing, terahertz (THz) communications, visible-light communications, near field communications (NFC) and/or other wireless communications. In one embodiment of the present invention, a plurality of BF modules 1402 may cover a plurality of standard wireless communications frequencies such that a DPA-MIMO system based foldable hand-held device 1400 may function at a plurality of wireless communication protocols.

It may be appreciated by a person with ordinary skill in the art that any signal and/or power may be sent between one or more elements of DPA-MIMO system based hand-held device. Signals and/or power sent between one or more elements may include, but not limited to, direct current (DC) power, control signals, reference signals, and/or feedback signals. In one embodiment of the present invention, an IF radio 1405 may provide DC power to one or more BF modules 1402 through one or more cables 1403. In another embodiment of the present invention, one or more IF radios 1405 may send control and reference signals through one or more cables 1403 to one or more BF modules 1402. BF modules 1402 may send feedback signals back to IF radios 1405 through cables 1403.

It may be appreciated by a person with ordinary skill in the art that one or more elements of a DPA-MIMO system based foldable hand-held device 1400 may be combined into a single functional group or separated into a plurality of functional groups. In one embodiment of the present invention, a plurality of sets each comprising of an IF radio 1405, a cable 1403, and a BF module 1402 may work individual functions such as, but not limited to, communications at a specific frequency, communications in a specific data stream, transmitting signals, and/or receiving signals. In another embodiment of the present invention, a plurality of sets comprising of one or more IF radios 1405, cables 1403, and BF modules 1402 may work a single function such as, but not limited to, communications at a specific frequency, communications in a specific data stream, transmitting signals, and/or receiving signals.

It may be appreciated by a person with ordinary skill in the art that one or more BF modules 1402 may cover a wide frequency range. A frequency range covered by one or more BF modules 1402 may include, but not limited to, WiFi bands above 6 GHz, wireless gigabit (WiGig) bands from 57-71 GHz, 76-81 GHz for radar services, and/or frequencies used by other wireless standards, licensed and unlicensed spectrum frequencies.

It may be appreciated by a person with ordinary skill in the art that the case/housing/frame of a foldable hand-held device 1401 includes one or more processors that may perform any type of process and/or algorithm on electronic signals. Processes and/or algorithms include, but are not limited to, digital beamforming techniques that process one or more signals from the one or more BF modules 1402 independently or jointly. BF modules 1402 may also perform functions such as, but not limited to, removing interferences and/or enhancing a single to noise ratio of the one or more processed signals and/or signals between antenna elements within one BF module 1402.

It may be appreciated by a person with ordinary skill in the art that such a DPA-MIMO system based foldable hand-held device 1400 may be for any wireless communication standard. Wireless communication standards include, but not limited to, the 2^{nd} Generation cellular system (2G), the 3^{rd} Generation cellular system (3G), the 4^{th} Generation cellular system (4G), the 5^{th} Generation cellular system (5G), the 5^{th} Generation and beyond cellular system, WLAN, Bluetooth, satellite communication, radar communication, and/or other wireless standards. In one embodiment of the present invention, 1400 may function at Bluetooth, NFC, and 3G/4G/5G wireless standards.

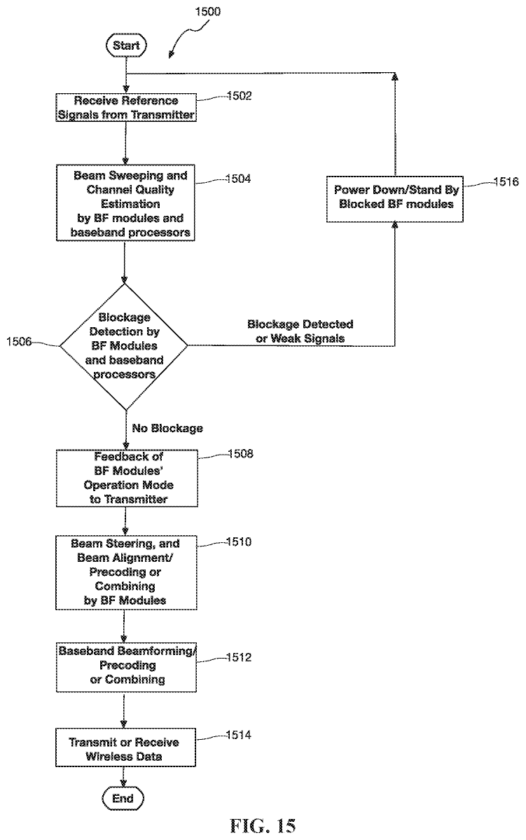

FIG. 15 is a flow chart illustrating an exemplary process for DPA-MIMO architecture based wireless communication systems 1500, in accordance with an embodiment of the present invention. 1500 comprises of a receive reference signal step 1502, a beam sweeping step 1504, a blockage detection step 1506, a feedback step 1508, a beam steeling and combining step 1510, a baseband beaming step 1512, a transmit or receive step 1514, and a power down step 1516.

DPA-MIMO wireless communication process 1500 begins with a receive reference signal step 1502. A DPA-MIMO wireless communication system such as, but not limited to, DPA-MIMO system such as DPA-MIMO system based wearable virtual reality device 500, may receive one or more reference signals on one or more signal receiving modules such as, but not limited to, antennas, BF modules such as BF module 502, optical receiver, etc.

A beam sweeping step 1504 may be performed by one or more BF modules such as BF module 502 wherein beam sweeping and channel estimation are performed. A blockage detection step 1506 may be performed by a processing unit such as, but not limited to, a baseband processing processor such as 506. The blockage detection step 1506 checks for whether a BF module such as BF module 502 is blocked.

If a blockage is detected in the blockage detection step 1506, a power down step 1516 is performed by a BF module such as BF module 502. In the power down step 1516, one or more BF modules such as BF module 502 may power down and/or enter a stand by state. BF modules such as BF module 502 may remain in a powered down and/or stand by state until a time interval has passed and DPA-MIMO wireless communication process 1500 re-enters a receive reference signal step 1502.

If a blockage is not detected in the blockage detection step 1506 by at least one or more BF modules such as BF module 502, a feedback step 1508 may be initiated from baseband processing unit such as baseband processor 506 and transmitted by one or more unblocked BF modules such as BF module 502. Information such as, but not limited to, operation mode and channel condition of every BF module's temperature, and/or bandwidth usage may be sent back to a transmitter within DPA-MIMO system such as DPA-MIMO system based wearable virtual reality device 500.

BF modules may perform a beam steering and beam alignment step 1510, in other words preceding for transmission and combining for reception. In beam steering and combining step 1510, beam steering and beam alignment will be performed to optimize DPA-MIMO system metrics such as, but not limited to, signal strength, power usage, and/or transmission data rate.

The baseband beaming step 1512 may be performed by a baseband processing unit such as baseband processor 506. Baseband beaming step 1512 may pre-code or combine signals within DPA-MIMO system such as DPA-MIMO system based wearable virtual reality device 500 depending whether DPA-MIMO system transmitting or receiving data. The transmit or receive step 1514 may be performed by one or more BF modules such as BF module 502 and transmits or receives wireless signals according to a transmission mode.

It may be appreciated by a person with ordinary skill in the art that one or more steps in the DPA-MIMO wireless communication process 1500 may be added, removed, or rearranged. In another embodiment of the present invention, DPA-MIMO wireless communication process 1500 may omit step the feedback step 1508 to reduce latency in DPA-MIMO system such as DPA-MIMO system based wearable virtual reality device 500. In still another embodiment of the present invention, the order of beam sweeping step 1504 and blockage detection step 1506 in DPA-MIMO wireless communication process 1500 may occur in any order. In still another embodiment of the present invention, additional steps such as, but not limited to, data encryption and/or signal multiplexing may be added to the DPA-MIMO wireless communication process 1500.

It may be appreciated by a person with ordinary skill in the art that one or more steps in the DPA-MIMO wireless communication process 1500 may be performed by one or more DPA-MIMO system modules, one or more electrical circuits, and/or one or more devices. The one or more of the steps of DPA-MIMO wireless communication process 1500 may be performed by devices such as, but not limited to, one or more user electronic devices, a computer network, and/or one or more DPA-MIMO system such as DPA-MIMO system based wearable virtual reality device 500. In another embodiment of the present invention, the steps of DPA-MIMO wireless communication process 1500 may be performed by a networked computing device over a wireless local area network (WLAN).

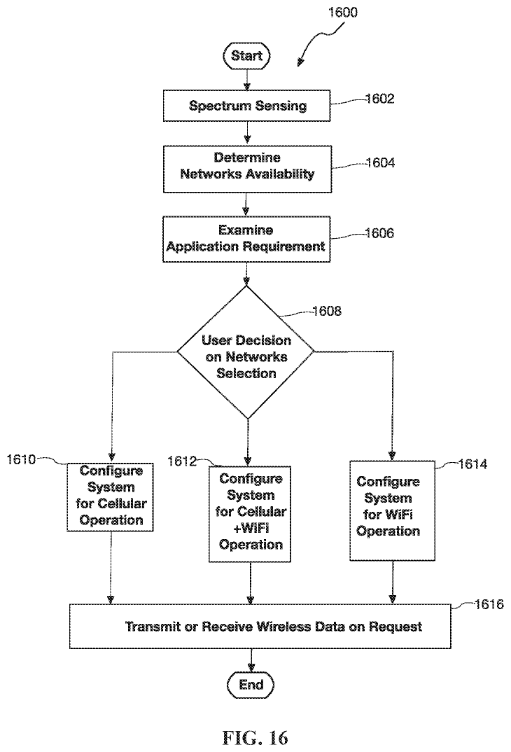

FIG. 16 is a flow chart illustrating an exemplary process for the cellular and WiFi co-enabled distributed phased array multiple-input-multiple-out system based wireless communication 1600, in accordance with an embodiment of the present invention. A process 1600 comprises of a spectrum sensing step 1602, a determine network availability step 1604, an examine application requirement step 1606, a network selection step 1608, a configure cellular operation step 1610, a configure cellular and WiFi operation step 1612, a configure WiFi operation step 1614, and a transmit or receive step 1616.

DPA-MIMO system based wireless communication process 1600 begins at the spectrum sensing step 1602. One or more BF modules such as BF module 502 may perform spectrum sensing to determine available frequencies and/or traffic for wireless communication.

One or more BF modules and/or a processing module may perform the determine networks availability step 1604. Network availability may be determined through passive means such as, but not limited to, sensor readings, traffic on a frequency, and/or noise on a frequency. Network availability may also be determined through active means such as, but not limited to, a message exchange between the cellular and WiFi co-enabled DPA-MIMO wireless communication system 1600 and a transmitter, a broadcast message from a transmitter, and/or a user input on a user equipment.

Examine application requirement step 1606 may be performed by a processing unit such as, but not limited to, a baseband processing unit such as baseband processor 506. Examine application requirement step 1606 evaluates an application's requirements to determine a network to use. Metrics to determine a suitable network include, but are not limited to, data rates, latency, and/or user input.

At network selection step 1608, a processing unit such as, but not limited to, a baseband processing unit such as baseband processor 506, may determine one or more networks to use based on any information from the examine application requirement step 1606. A configure cellular operation step 1610, a configure cellular and WiFi operation step 1612, or a configure WiFi operation step 1614 may be performed based on the determination of which network must be used. Network determination may also be determined by factors such as, but not limited to, incoming wireless signals to a user device, traffic on a network, and/or a transmitter's network. It may be appreciated by a person with ordinary skill in the art that any type of wireless network may be supported. Wireless networks may be, but not limited to, Bluetooth, WiFi, NFC, and/or cellular.

The transmit and/or receive step 1616 may be performed by any transmission hardware such as, but not limited to, one or more BF modules, one or more IF radio modules, and transmits or receives wireless signals according to a transmission mode based on the operation state of cellular and WiFi co-enabled. DPA-MIMO system based wireless communication system.

It may be appreciated by a person with ordinary skill in the art that the cellular and WiFi co-enabled DPA-MIMO system based wireless communication process 1600 is not limited to a cellular and WiFi combination cellular and WiFi co-enabled DPA-MIMO wireless communication process 1600 may be any combination of two or more wireless communication technologies. In one embodiment of the present invention, cellular and WiFi co-enabled DPA-MIMO wireless communication process 1600 may be configured for Bluetooth, NFC, and amateur radio wireless communications. In another embodiment of the present invention, a configure cellular operation step 1610, a configure cellular and WiFi operation step 1612, and a configure WiFi operation step 1614 may each individually configure cellular and WiFi co-enabled DPA-MIMO system based wireless communication for one or more wireless communication protocols.

It may be appreciated by a person with ordinary skill in the art that a configure cellular and WiFi operation step 1612 is not limited to the cellular and WiFi combination based on existing frequency bands/spectrum used by cellular and WiFi standards. Such a configure may need to enable a broader and more powerful carrier aggregation (e.g. super carrier aggregation (Super-CA)) of all currently available frequency bands (e.g., sub-6 GHz, mmWave bands) and any other potentially available frequency bands (e.g. beyond 95 GHz and THz, visible light bands).

It may be appreciated by a person with ordinary skill in the art that one or more steps in the cellular and WiFi co-enabled DPA-MIMO system based wireless communication process 1600 may be added, removed, or rearranged. In another embodiment of the present invention, the cellular and WiFi co-enabled DPA-MIMO system based wireless communication process 1600 may omit step the spectrum sensing step 1602 to reduce latency in the cellular and WiFi co-enabled DPA-MIMO system based wireless communication. In still another embodiment of the present invention, the determine network availability step 1604 and the examine application requirement step 1606 in the cellular and WiFi co-enabled DPA-MIMO system based wireless communication process 1600 may occur in any order. In still another embodiment of the present invention, additional steps such as, but not limited to, data encryption and/or signal multiplexing may be added to the cellular and WiFi co-enabled DPA-MIMO system based wireless communication 1600.

It may be appreciated by a person with ordinary skill in the art that one or more steps in the cellular and WiFi co-enabled DPA-MIMO system based wireless communication process 1600 may be performed by modules of one or more cellular and WiFi co-enabled DPA-MIMO wireless communication systems such as a DPA-MIMO system based wearable virtual reality device 500, one or more electrical circuits, and/or one or more devices. The one or more of the steps of the cellular and WiFi co-enabled DPA-MIMO wireless communication process 1600 may be performed by devices such as, but not limited to, one or more user electronic devices, a computer network, and/or one or more cellular and WiFi co-enabled DPA-MIMO system based wireless communication systems such as 500. In another embodiment of the present invention, the steps of the cellular and WiFi co-enabled DPA-MIMO system based wireless communication process 1600 may be performed by a networked computing device over a wireless local area network (WLAN).

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing distributed phased arrays based multiple-input-multiple-output in hardware designs according to the present invention will be apparent to those skilled in the art. Various aspects of the invention have been described above by way of illustration, and the specific embodiments disclosed are not intended to limit the invention to the particular forms disclosed. The particular implementation of the DPA-MIMO in hardware designs may vary depending upon the particular context or application. By way of example, and not limitation, the DPA-MIMO in hardware designs described in the foregoing were principally directed to consumer electronics implementations; however, similar techniques may instead be applied to the Internet of Things applications such as vehicle to vehicle or sensor to sensor communications, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

What is claimed is:

1. A system for distributed phased array multiple input multiple output DPA-MIMO) communications, comprising:
a baseband processing unit.;
a plurality of beamforming (BF) modules, each beamforming module comprises at least a beamforming antenna and a transceiver circuit comprising at least a downconverter that downconverts a beamformed antenna radio frequency signal to an intermediate frequency signal, and an upconverter that upconverts an intermediate frequency signal to radio frequency and sends to said beamforming antenna for transmission; and
a plurality of intermediate frequency (IF) radios, each intermediate frequency radio comprises a receive chain circuit that includes at least a downconverter that downconverts an intermediate frequency signal sent from said BF module to a baseband signal conveyed to said baseband processing unit, and a transmit chain circuit that includes at least an upconverter that upconverts a baseband signal received from said baseband processing unit to an intermediate frequency signal that is conveyed to said beamforming module;
wherein based on at least one of: an account available physical space, a beamforming module dimension, a total number of BF modules, heat dissipation, a target spatial multiplexing gain, or a target diversity gain, said plurality of BF modules are placed in a distributed way with an edge-to-edge spacing that maximally reduces mutual coupling and propagation interference, whereby signal diversity and signal quality are enhanced among said BF modules.

2. A wearable virtual reality device headset, comprising the system of claim 1, wherein the placement and number of any elements of BF modules, IF radios and baseband processors, to the wearable virtual reality device headset, are determined by any metrics or purposes including user experience, heat dissipation, power usage, signal reception/transmission quality, and device aesthetic.

3. A virtual reality base station, comprising the system of claim 1, wherein the placement and number of any elements of BF modules, IF radios and baseband processors, to the virtual reality base station housing, are determined by any metrics or purposes including user experience, heat dissipation, power usage, signal reception/transmission quality, and device aesthetic.

4. A virtual reality theater, comprising the method of claim 1, wherein the placement and number of any elements of BF modules, IF radios and baseband processors, the wearable virtual reality devices, to the virtual reality base stations, are determined by any metrics or purposes including user experience, heat dissipation, power usage, signal reception/transmission quality, user experiences, system and building aesthetic.

5. A virtual reality shopping mall, comprising the method of claim 1, wherein the placement and number of any elements of BF modules, IF radios and baseband processors, the wearable virtual reality devices, to the virtual reality base stations, are determined by any metrics or purposes including user experience, heat dissipation, power usage, signal reception/transmission quality, system and building aesthetic.

6. A virtual reality school campus, comprising the method of claim 1, wherein the placement and number of any elements of BF modules, IF radios and baseband processors, the wearable virtual reality devices, to the virtual reality base stations, are determined by any metrics or purposes including user experience, heat dissipation, power usage, signal reception/transmission quality, system and building aesthetic.

7. A brain-machine interface device, comprising the method of claim 1, wherein the placement and number of any elements of BF modules, IF radios and baseband processors, to the wearable virtual reality device headset, are determined by any metrics or purposes including user experience, form factor, heat dissipation, power usage, signal reception/transmission quality, and device aesthetic,

8. An implantable device, comprising the method of claim 1, wherein the placement and number of any elements of BF modules, IF radios and baseband processors, to the wearable virtual reality device headset, are determined by any metrics or purposes including user experience, form factor, heat dissipation, power usage, signal reception/transmission quality, and device aesthetic.

9. An automotive vehicle, comprising the system of claim 1, wherein the placement and number of any elements of BF modules, IF radios and baseband processors, to the automotive vehicle body and chassis, are determined by any metrics or purposes including user experience, heat dissipation, power usage, signal reception/transmission quality, and device aesthetic.

10. An unmanned aerial vehicle, comprising the system of claim 1, wherein the placement and number of any elements of BF modules, IF radios and baseband processors, to the unmanned aerial vehicle body and chassis, are determined by any metrics or purposes including user experience, heat dissipation, power usage, signal reception/transmission quality, and device aesthetic.

11. A high-altitude communication box, comprising the system of claim 1, wherein the placement and number of any elements of BF modules, IF radios and baseband processors, to the high-altitude communication box case/housing/frame, are determined by any metrics or purposes including user experience, heat dissipation, power usage, signal reception/transmission quality, and device aesthetic.

12. A communication equipment used for spacecraft, comprising the method of claim 1, wherein the placement and number of any elements of BF modules, IF radios and baseband processors, to the spacecraft case/housing/frame, are determined by any metrics or purposes including user experience, heat dissipation, power usage, signal reception/transmission quality, reliability, device and system aesthetic.

13. A foldable hand-held device, comprising the system of claim 1, wherein the placement and number of any elements of BF modules, IF radios and baseband processors, to the foldable hand-held device case/housing/frame, are determined by any metrics or purposes including user experience, heat dissipation, power usage, signal reception/transmission quality, device and system aesthetic.

14. A method for distributed phased arrays multiple input multiple output (DPA-MIMO) communications, or comprising:
a baseband processing unit;
a plurality of beamforming (BF) modules each of which comprises at least a beamforming antenna and a transceiver circuit comprising at least a downconverter that downconverts a beamformed antenna radio frequency signal to an intermediate frequency signal, and an upconverter that upconverts an intermediate frequency signal to radio frequency and sends to said beamforming antenna for transmission;
a plurality of intermediate frequency (IF) radios, each of which comprises a receive chain circuit that includes at least a downconverter that downconverts an intermediate frequency signal sent from said BF module to a baseband signal conveyed to said baseband processing unit, and a transmit chain circuit that includes at least an upconverter that upconverts a baseband signal received from said baseband processing unit to an intermediate frequency signal which is conveyed to said beamforming module;
and
a plurality of cables or any type of physical signal transmission medium, each of which connects one of said beamforming modules with one of said intermediate frequency radios.

15. A method for wearable virtual reality device headset, comprising the system of claim 14, wherein the placement and number of any elements of BF modules, IF radios and baseband processors, to the wearable virtual reality device headset, are determined by any metrics or purposes including user experience, heat dissipation, power usage, signal reception/transmission quality, and device aesthetic.

16. A method for virtual reality base station, comprising the method of claim 14, wherein the placement and number of any elements of BF modules, IF radios and baseband processors, the virtual reality base station housing, are determined by any metrics or purposes including user experience, heat dissipation, power usage, signal reception/transmission quality, and device aesthetic.

17. A method for automotive vehicle, comprising the method of claim 14, wherein the placement and number of any elements of BF modules, IF radios and baseband processors, to the automotive vehicle body and chassis, are determined by any metrics or purposes including user experience, heat dissipation, power usage, signal reception/transmission quality, and device aesthetic.

18. A method for unmanned aerial vehicle, comprising the method of claim 14, wherein the placement and number of any elements of BF modules, IF radios and baseband processors, to the unmanned aerial vehicle body and chassis, are determined by any metrics or purposes including user experience, heat dissipation, power usage, signal reception/transmission quality, and device aesthetic.

19. A method for high-altitude communication box, comprising the method of claim 14, wherein the placement and number of any elements of BF modules, IF radios and baseband processors, to the high-altitude communication box case/housing/frame, are determined by any metrics or purposes including user experience, heat dissipation, power usage, signal reception/transmission quality, and device aesthetic.

20. A method for foldable hand-held device, comprising the method of claim 14, wherein the placement and number of any elements of BF modules, IF radios and baseband processors, to the foldable hand-held device case/housing/frame, are determined by any metrics or purposes including user experience, heat dissipation, power usage, signal reception/transmission quality, and device aesthetic.
